(19) United States
(12) Patent Application Publication
(10) Pub. No.: US 2017/0032506 A1
(43) Pub. Date: Feb. 2, 2017

(54) IMAGE PROCESSING APPARATUS AND CONTROL METHOD THEREOF

(71) Applicant: CANON KABUSHIKI KAISHA, Tokyo (JP)

(72) Inventor: Takashi Asaka, Tokyo (JP)

(21) Appl. No.: 15/217,473

(22) Filed: Jul. 22, 2016

(30) Foreign Application Priority Data
Jul. 28, 2015 (JP) 2015-148892
Jun. 29, 2016 (JP) 2016-128527

(51) Int. Cl. G06T 5/50; G06T 11/60; G06T 5/00

(52) U.S. Cl. CPC G06T 5/50; G06T 5/008; G06T 11/60; G06T 2207/10024

(57) ABSTRACT

An image processing apparatus includes: a first processing unit configured to apply first image processing to input image data; a communicating unit configured, by communicating with other image processing apparatus having a second processing unit performing second image processing that differs from the first image processing, to cause the second processing unit to perform the second image processing on the input image data, and to acquire a result of the second image processing applied to the input image data from the other image processing apparatus; and a combining unit configured to perform a combining process of combining together a result of the first image processing by the first processing unit and the result of the second image processing acquired by the communicating unit.

### BACKGROUND OF THE INVENTION

Field of the Invention

The present invention relates to an image processing apparatus and a control method thereof.

Description of the Related Art

In recent years, resolution enhancement of image data that can be displayed by an image display apparatus has been realized. Accordingly, there are demands to achieve resolution enhancement of image data that can be processed by an image processing apparatus. As a method of processing high resolution image data, there is a method of processing, in parallel with a plurality of image processing apparatuses, a plurality of pieces of partial image data corresponding to a plurality of partial images that constitute an original image represented by original image data. Each partial image is an image in a partial region of the original image. With this method, for example, image processing on original image data constituted by 10 million pixels can be realized using two image processing apparatuses respectively capable of processing image data constituted by 5 million pixels. Constructing an image processing system which performs image processing according to the method described above (a system having a plurality of image processing apparatuses) is easier than developing a new image processing apparatus capable of processing high resolution image data.

In addition, opportunities of using image data with a wide brightness dynamic range that is referred to as high dynamic range (HDR) image data have increased. In a case where HDR image data is a target of image processing, an image processing apparatus is to process image data with various degrees of brightness ranging from low brightness to extremely high brightness. However, realizing image processing on HDR image data using a conventional lookup table (LUT) causes deterioration in image quality due to insufficient image processing accuracy. For example, blocked-up shadows are created in a case where a low brightness pixel value (gradation value) of input image data that is image data prior to image processing is converted to a lower limit value by the image processing. A conventional LUT is an LUT created by, for example, only taking image data with a standard dynamic range of brightness (standard dynamic range (SDR) image data) into consideration.

As a method of preventing the deterioration in image quality which occurs in image processing of HDR image data, a method of increasing the number of words in an LUT is conceivable. Specifically, a method is conceivable in which a range of addresses in the LUT are expanded and the number of referable addresses in the LUT is increased. However, the number of words in an LUT is limited by a capacity of a memory (for example, a static random access memory (SRAM)) which constitutes the LUT. In addition, since an increase in memory capacity causes an increase in cost of an image processing apparatus, a total amount of a memory cannot be increased without careful consideration.

As a method of realizing image processing using a larger number of addresses than normal and, at the same time, using addresses with a wider range than normal as referable addresses, a method of dynamically rewriting an LUT during image processing is conceivable. For example, in a case where brightness of each pixel of input image data concentrates in a partial brightness range, addresses in a range corresponding to the brightness range are to be referred to in a concentrated manner. Therefore, a method is conceivable in which an address set (mapped) to the LUT is rewritten from an address in a range with a low probability of being referred to, to an address in a range with a high probability of being referred to. However, with this method, image disturbance (image quality deterioration) occurs due to reading of an address being rewritten in the LUT.

Conventional art related to rewriting an LUT during image processing is disclosed in, for example, Japanese Patent Application Laid-open No. 2005-266576. With the technique disclosed in Japanese Patent Application Laid-open No. 2005-266576, an address in a vicinity of an address being rewritten is referred to instead of the address being rewritten. Accordingly, an occurrence of a significant image disturbance is suppressed. However, with the technique disclosed in Japanese Patent Application Laid-open No. 2005-266576, a desired address cannot always be referred to at a desired timing. Therefore, in cases where a brightness range of input image data changes and the like, image quality deterioration may occur.

In order to prevent an occurrence of the image quality deterioration attributable to rewriting of an LUT, favorably, addresses in a certain range can always be accessed during image processing.

As a method of increasing the number of words in an LUT, a method of reducing a bit depth per word is conceivable. However, reducing bit depth causes image processing accuracy to decline. In addition, there are cases where an LUT which is desirably used differs among a plurality of regions of an image. However, constructing a plurality of LUTs using one memory causes memory capacity per region to decrease and results in a decline in image processing accuracy. Obviously, providing a plurality of memories respectively constructing a plurality of LUTs in an image processing apparatus results in an increase in cost of the image processing apparatus.

### SUMMARY OF THE INVENTION

The present invention provides a technique that enables a highly accurate image processing result to be obtained without increasing cost of an image processing apparatus.

The present invention in its first aspect provides an image processing apparatus comprising:
a first processing unit configured to apply first image processing to input image data;
a communicating unit configured, by communicating with other image processing apparatus having a second processing unit performing second image processing that differs from the first image processing, to cause the second processing unit to perform the second image processing on the input image data, and to acquire a result of the second image processing applied to the input image data from the other image processing apparatus; and
a combining unit configured to perform a combining process of combining together a result of the first image processing by the first processing unit and the result of the second image processing acquired by the communicating unit.

The present invention in its second aspect provides an image processing system comprising a first image processing apparatus and a second image processing apparatus,
the first image processing apparatus including:
a first processing unit configured to apply first image processing to first input image data that is image data input to the first image processing apparatus;
a first communicating unit configured to communicate with the second image processing apparatus; and
a first combining unit configured to perform a first combining process of combining together a result of the first image processing by the first processing unit and a result of communication by the first communicating unit,
the second image processing apparatus including a second processing unit configured to perform second image processing that differs from the first image processing, wherein
the first communicating unit, by communicating with the second image processing apparatus, causes the second processing unit to perform the second image processing on the first input image data, and acquires a result of the second image processing applied to the first input image data from the second image processing apparatus, and
the first combining process is a process of combining together a result of the first image processing on the first input image data and the result of the second image processing acquired by the first communicating unit.

The present invention in its third aspect provides a control method of an image processing apparatus including a first processing unit configured to perform first image processing,
the control method comprising:
a processing step of causing the first processing unit to perform the first image processing on input image data that is image data input to the image processing apparatus;
a communicating step of, by communicating with other image processing apparatus having a second processing unit performing second image processing that differs from the first image processing, causing the second processing unit to perform the second image processing on the input image data, and acquiring a result of the second image processing applied to the input image data from the other image processing apparatus; and
a combining step of performing a combining process of combining together a result of the first image processing acquired in the processing step and the result of the second image processing acquired in the communication step.

The present invention in its fourth aspect provides a non-transitory computer readable medium that stores a program, wherein
the program causes a computer to execute a control method of an image processing apparatus including a first processing unit configured to perform first image processing, and
the control method includes:
a processing step of causing the first processing unit to perform the first image processing on input image data that is image data input to the image processing apparatus;
a communicating step of, by communicating with other image processing apparatus having a second processing unit performing second image processing that differs from the first image processing, causing the second processing unit to perform the second image processing on the input image data, and acquiring a result of the second image processing applied to the input image data from the other image processing apparatus; and
a combining step of performing a combining process of combining together a result of the first image processing acquired in the processing step and the result of the second image processing acquired in the communication step.

According to the present invention, a highly accurate image processing result can be obtained without increasing cost of an image processing apparatus.

Further features of the present invention will become apparent from the following description of exemplary embodiments with reference to the attached drawings.

### BRIEF DESCRIPTION OF THE DRAWINGS

FIG. 1 is a diagram showing an example of a configuration of an image processing apparatus according to a first embodiment;

FIG. 2 is a diagram showing an example of a configuration of an LUT according to the first embodiment;

FIG. 3 is a diagram showing an example of a configuration of an LUT according to the first embodiment;

FIG. 4 is a diagram showing an example of a configuration of an image processing system according to the first embodiment;

FIG. 5 is a diagram showing an example of a configuration of an LUT according to the first embodiment;

FIG. 6 is a diagram showing an example of a processing flow of an image processing system according to the first embodiment;

FIG. 7 is a diagram showing an example of processing timings of an image processing system according to the first embodiment;

FIG. 8 is a diagram showing an example of a configuration of an image processing apparatus according to a second embodiment;

FIG. 9 is a diagram showing an example of a configuration of an image processing system according to the second embodiment;

FIG. 10 is a diagram showing an example of a processing flow of an LUT setting process according to the second embodiment;

FIG. 11 is a diagram showing an example of a first input image and a second input image according to the second embodiment;

FIG. 12 is a diagram showing an example of a first input image and a second input image according to the second embodiment;

FIG. 13 is a diagram showing an example of a first input image and a second input image according to the second embodiment;

FIG. 14 is a diagram showing an example of a processing flow of an image processing system according to the second embodiment;

FIG. 15 is a diagram showing an example of a processing flow of a cooperative process according to the second embodiment;

FIG. 16 is a diagram showing an example of processing timings of an image processing system according to the second embodiment;

FIG. 17 is a diagram showing an example of processing timings of an image processing system according to the second embodiment;

FIG. 18 is a diagram showing an example of a configuration of an image processing apparatus according to a third embodiment;

FIG. 19 is a diagram showing an example of a configuration of an image processing system according to the third embodiment;

FIG. 20 is a diagram showing an example of a configuration of an LUT according to the third embodiment;

FIG. 21 is a diagram showing an example of a processing flow of an image processing system according to the third embodiment;

FIG. 22 is a diagram showing an example of processing timings of an image processing system according to the third embodiment;

FIG. 23 is a diagram showing an example of a configuration of an image processing apparatus according to a fourth embodiment;

FIG. 24 is a diagram showing an example of a configuration of an image processing system according to the fourth embodiment;

FIG. 25 is a diagram showing an example of a configuration of an LUT according to the fourth embodiment;

FIG. 26 is an explanatory diagram of a delay adjusting unit according to the fourth embodiment;

FIG. 27 is a diagram showing an example of a processing flow of an image processing system according to the fourth embodiment;

FIG. 28 is a diagram showing an example of a configuration of an image processing apparatus according to a fifth embodiment;

FIG. 29 is a diagram showing an example of a configuration of an LUT according to the fifth embodiment;

FIG. 30 is a diagram showing an example of a configuration of an LUT according to the fifth embodiment;

FIG. 31 is a diagram showing an example of a configuration of an image processing system according to the fifth embodiment;

FIG. 32 is a diagram showing an example of a configuration of an LUT according to the fifth embodiment; and

FIG. 33 is a diagram showing an example of a processing flow of an image processing system according to the fifth embodiment.

### DESCRIPTION OF THE EMBODIMENTS

### First Embodiment

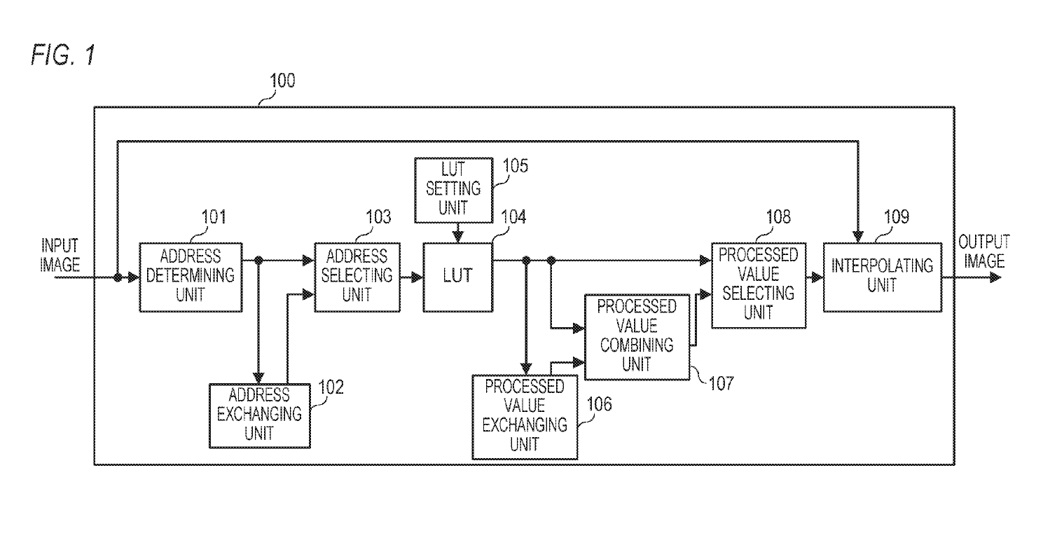

Hereinafter, an image display apparatus and a control method thereof according to a first embodiment of the present invention will be described. FIG. 1 is a block diagram showing an example of a configuration of an image processing apparatus 100 according to the present embodiment. The image processing apparatus 100 is used in, for example, an image processing system having a plurality of image processing apparatuses.

An address determining unit 101 determines an address in accordance with a pixel value of input image data (address determining process). Input image data refers to image data input to the image processing apparatus 100. An address determining process is performed with respect to each pixel of the input image data. In an address determining process, for example, an address is determined in accordance with a value of several high order bits of the pixel value of the input image data.

An address exchanging unit 102 communicates with other image processing apparatus. Specifically, the address exchanging unit 102 outputs an address determined by the address determining unit 101 to the other image processing apparatus and acquires an address from the other image processing apparatus.

An address selecting unit 103 selects one of the address determined by the address determining unit 101 and the address acquired from the other image processing apparatus by the address exchanging unit 102 and outputs the selected address to an LUT 104.

The LUT 104 is a lookup table (LUT) for applying first image processing to the input image data. In a case where an address (input value) is input, the LUT 104 outputs an output value (a first processed value that is a pixel value after first image processing) corresponding to the input address. In a case where the address determined by the address determining unit 101 is input to the LUT 104, the first image processing is to be applied to the input image data at the LUT 104.

An LUT setting unit 105 performs settings of the LUT 104.

A processed value exchanging unit 106 communicates with the other image processing apparatus. Specifically, the processed value exchanging unit 106 outputs the processed value obtained by the LUT 104 to the other image processing apparatus and acquires a processed value from the other image processing apparatus.

In the present embodiment, the other image processing apparatus has an LUT for performing second image processing which differs from the first image processing. The LUT included in the other image processing apparatus will be hereinafter referred to as the “other LUT”. The address exchanging unit 102 communicates with the other image processing apparatus to have the other LUT perform the second image processing on the input image data. Specifically, in a case where the address determined by the address determining unit 101 is output from the address exchanging unit 102 to the other image processing apparatus, the address determined by the address determining unit 101 is input to the other LUT. As a result, as an output value of the other LUT, a second processed value which is a result of applying the second image processing to the pixel value of the input image data is obtained. Therefore, “a process of having the other LUT perform the second image processing on the input image data” can be rephrased as “a process of having the other LUT output an output value corresponding to the address determined by the address determining unit 101”. In addition, by communicating with the other image processing apparatus, the processed value exchanging unit 106 acquires the second processed value which is a result of applying the second image processing to the pixel value of the input image data from the other image processing apparatus. Furthermore, the processed value exchanging unit 106 outputs a processed value corresponding to an address acquired from the other image processing apparatus to the other image processing apparatus.

Alternatively, a single communicating unit having functions of the address exchanging unit 102 and the processed value exchanging unit 106 may be used in place of the address exchanging unit 102 and the processed value exchanging unit 106.

A processed value combining unit 107 performs a combining process in which a result of the first image processing by the LUT 104 and a result of the second image processing acquired by the processed value exchanging unit 106 are combined together. The combining process is a process of combining together a result of applying the first image processing to the input image data and a result of applying the second image processing to the input image data. In the present embodiment, the combining process is a process of combining together a first processed value that is an output value of the LUT 104 corresponding to an address in accordance with the pixel value of the input image data and a second processed value that is an output value of the other LUT corresponding to the address. In the present embodiment, the combining process is performed with respect to each pixel of the input image data. In addition, the processed value combining unit 107 outputs a processed value after the combining process (a combined processed value).

A processed value selecting unit 108 selects one of the first processed value that is an output value of the LUT 104 and a combined processed value that is an output value of the processed value combining unit 107 and outputs the selected processed value.

An interpolating unit 109 performs an interpolating operation of the selected processed value based on the pixel value of the input image data. Moreover, all of the bits of the pixel value of the input image data may be used for the interpolating operation or a part of the bits of the pixel value of the input image data may be used for the interpolating operation. For example, let us assume that several high order bits among the plurality of bits constituting the pixel value of the input image data are used in a case where the address determining unit 101 determines an address. In this case, several low order bits not used when the address determining unit 101 determines the address among the plurality of bits constituting the pixel value of the input image data may be used for the interpolating operation. The interpolating operation may be an operation that realizes linear interpolation or an operation that realizes nonlinear interpolation. The interpolating unit 109 outputs a processed value after the interpolating operation as a pixel value of output image data.

Alternatively, the processed value selecting unit 108 and the interpolating unit 109 may be omitted and the combined processed value may be used as a pixel value of the output image data.

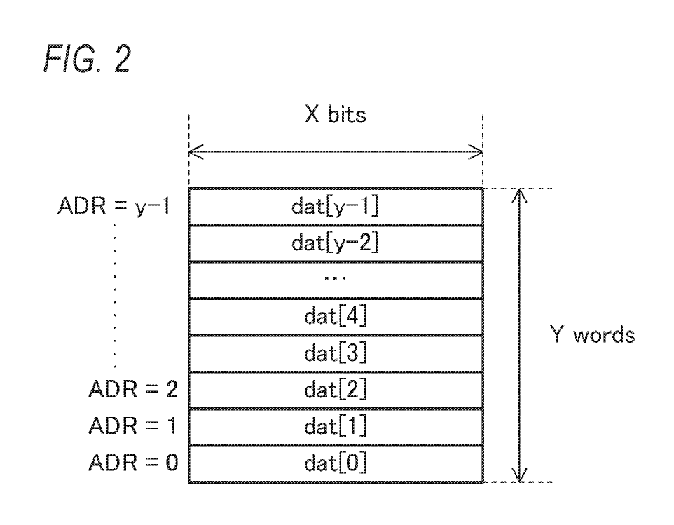

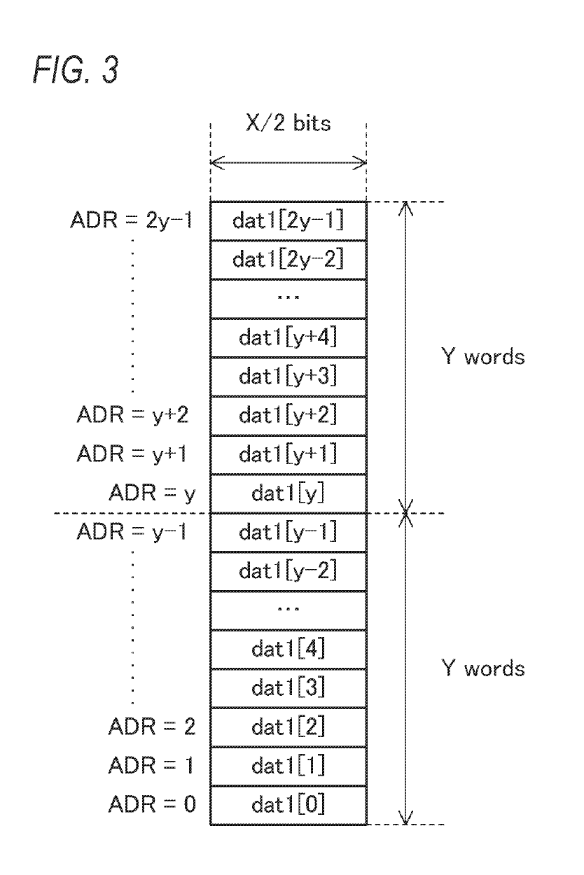

Setting of the LUT 104 performed by the LUT setting unit 105 will now be described with reference to FIGS. 2 and 3.

In this case, it is assumed that the LUT 104 is constituted by a static random access memory (SRAM) having a data capacity of X×Y-number of bits. The LUT setting unit 105 determines a bit width of each first processed value constituting the LUT 104 and the number of words (an address range) of the LUT 104 so as to fit into the size of the SRAM. In addition, the LUT setting unit 105 maps addresses and first processed values to the SRAM in accordance with the determined bit width and the determined number of words. As a result, the LUT 104 is set which indicates addresses in the determined range (number of words) and in which a first processed value having the determined bit width is associated with each address.

FIG. 2 is a diagram showing an example of a configuration of the LUT 104. FIG. 2 shows a case where the bit width of the first processed value per word (per address) is X-number of bits and the number of words is Y-number of words. Setting the LUT 104 shown in FIG. 2 requires a data capacity of X×Y-number of bits (=X-number of bits×Y-number of words). As described above, the data capacity of the SRAM is X×Y-number of bits. Therefore, the LUT 104 shown in FIG. 2 can be set. In FIG. 2, “ADR=x” indicates an address x and dat [x] indicates a first processed value corresponding to the address x.

FIG. 3 also shows an example of a configuration of the LUT 104. FIG. 3 represents an example of a case where the number of words is 2Y-number of words (twice as in FIG. 2). However, in a case where X-number of bits (the same value as in FIG. 2) is used as a bit width of the first processed value per word, the data capacity necessary for setting the LUT 104 exceeds the data capacity (X×Y-number of bits) of the SRAM and the LUT 104 cannot be set. Specifically, a data capacity of 2×X×Y-number of bits (=X-number of bits×2Y-number of words) is required to set the LUT 104. Therefore, in the example shown in FIG. 3, X/2-number of bits is used as the bit width of the first processed value per word. Accordingly, the data capacity necessary for setting the LUT 104 can be kept at X×Y-number of bits (=X/2-number of bits×2Y-number of words) and the LUT 104 can be set. In the present embodiment, an example of a case where the LUT 104 shown in FIG. 3 is set will be described. In FIG. 3, “ADR=x” indicates an address x and dat1 [x] indicates a first processed value corresponding to the address x.

In a case of performing image processing on image data with a wide brightness dynamic range that is referred to as high dynamic range (HDR) image data, the number of words (an address range) of an LUT can conceivably be increased. However, as shown in FIG. 3, enlarging the address range reduces the bit width of a processed value per word and causes accuracy of the processed value per word to decline. While a decline in the accuracy of a processed value can be suppressed by increasing the data capacity of the SRAM, this results in increased cost of an image processing apparatus.

In consideration thereof, in the present embodiment, an improvement in accuracy of an LUT used for image processing is achieved by using other image processing apparatus. Specifically, using the other image processing apparatus, an address range (the number of words) is increased without lowering the accuracy of a processed value per word. As a result, a highly accurate image processing result can be obtained without increasing cost of an image processing apparatus.

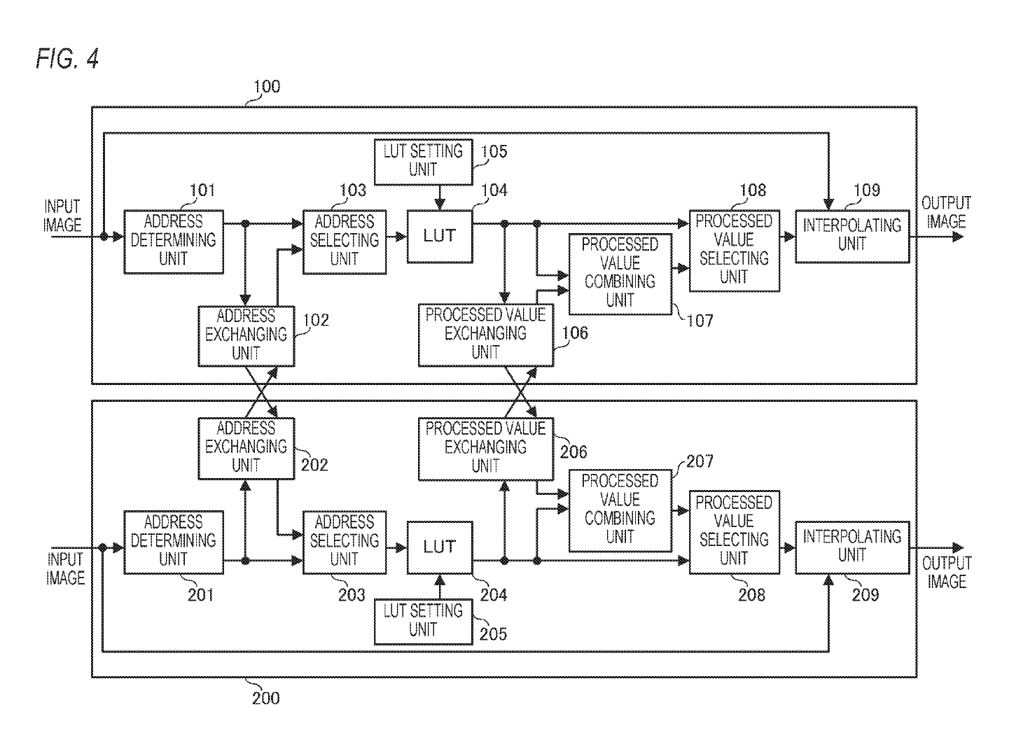

FIG. 4 is a block diagram showing an example of a configuration of an image processing system according to the present embodiment. As shown in FIG. 4, the image processing system according to the present embodiment includes the image processing apparatus 100 and an image processing apparatus 200. Alternatively, the image processing system may include three or more image processing apparatuses. The image processing apparatus 200 includes an address determining unit 201, an address exchanging unit 202, an address selecting unit 203, an LUT 204, an LUT setting unit 205, a processed value exchanging unit 206, a processed value combining unit 207, a processed value selecting unit 208, and an interpolating unit 209.

The address determining unit 201 has a similar function to the address determining unit 101. The address exchanging unit 202 has a similar function to the address exchanging unit 102. The address selecting unit 203 has a similar function to the address selecting unit 103. The LUT 204 has a similar function to the LUT 104. The LUT setting unit 205 has a similar function to the LUT setting unit 105. The processed value exchanging unit 206 has a similar function to the processed value exchanging unit 106. The processed value combining unit 207 has a similar function to the processed value combining unit 107. The processed value selecting unit 208 has a similar function to the processed value selecting unit 108. In addition, the interpolating unit 209 has a similar function to the interpolating unit 109. In other words, the image processing apparatus 200 has a similar configuration to the image processing apparatus 100. The image processing apparatus 200 performs processing which may be described by replacing the term “first” in the description related to the processing by the image processing apparatus 100 provided above with the term “second”.

Communication for transmitting and receiving addresses is performed between the address exchanging unit 102 and the address exchanging unit 202 and communication for transmitting and receiving processed values is performed between the processed value exchanging unit 106 and the processed value exchanging unit 206.

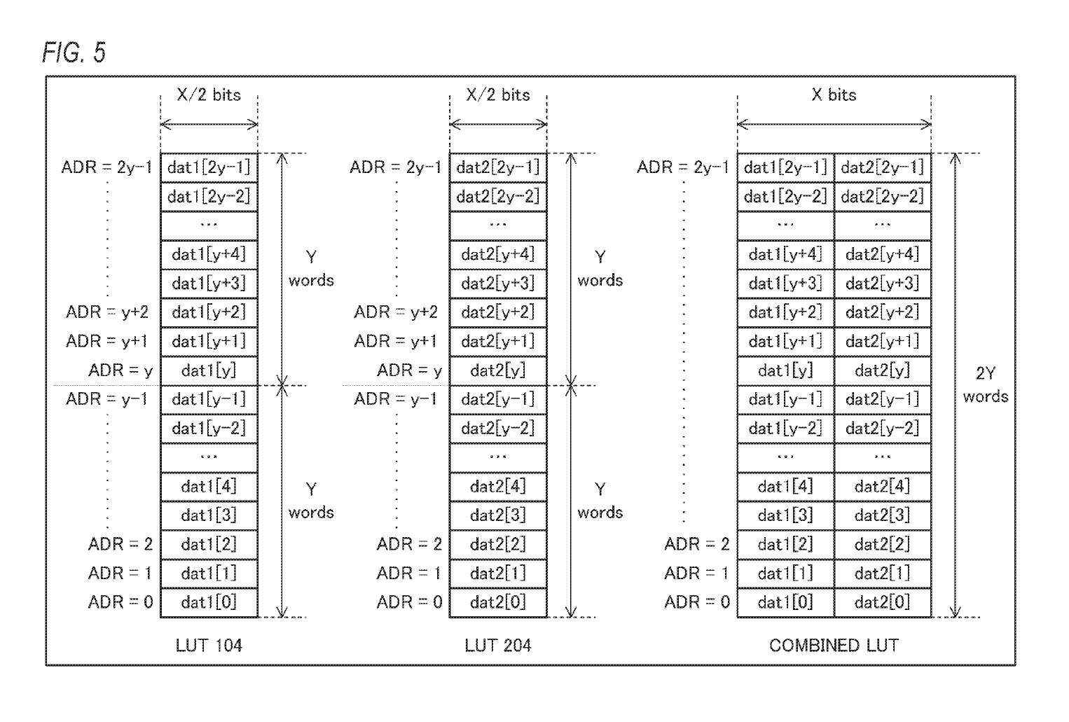

FIG. 5 shows an example of the LUT 104, the LUT 204, and a combined LUT obtained by combining the LUT 104 and the LUT 204 together. The LUT 104 is shown on a left side of FIG. 5, the LUT 204 is shown in a center of FIG. 5, and the combined LUT is shown on a right side of FIG. 5. The LUT 104 shown in FIG. 5 is the same as the LUT 104 shown in FIG. 3. In the LUT 204 shown in FIG. 5, the bit width of a processed value (a second processed value) per word is X/2-number of bits and the number of words is 2Y-number of words in a similar manner to the LUT 104 shown in FIG. 5. In FIG. 5, “ADR=x” indicates an address x, dat1 [x] indicates a first processed value corresponding to the address x, and dat2 [x] indicates a second processed value corresponding to the address x.

As the first processed value dat1, the present embodiment uses a first partial value that is any of a plurality of partial values constituting a pixel value obtained by performing predetermined image processing (image processing with high accuracy) on a pixel value. In addition, as the second processed value dat2, a second partial value which is any of the plurality of partial values and which differs from the first partial value is used. By combining the first partial value and the second partial value together, a processed value with a higher accuracy than the first processed value dat1 and the second processed value dat2 can be obtained as a combined processed value. For example, the number of the plurality of partial values matches the number of image processing apparatuses included in the image processing system. By combining a plurality of partial values obtained from the plurality of image processing apparatuses, a same pixel value as a result of highly accurate image processing can be obtained.

In the present embodiment, as an LUT that realizes the predetermined image processing, an LUT in which the bit width of a processed value per word is X-number of bits and the number of words is 2Y-number of words is assumed. In addition, X/2-number of high order bits of a processed value with X-number of bits is used as the first processed value dat1 and X/2-number of low order bits of the processed value with X-number of bits is used as the second processed value dat2. Furthermore, as shown in FIG. 5, by combining the first processed value dat1 and the second processed value dat2 together, a result of image processing using an highly accurate LUT (an LUT in which the bit width is X-number of bits and the number of words is 2Y-number of words) can be obtained.

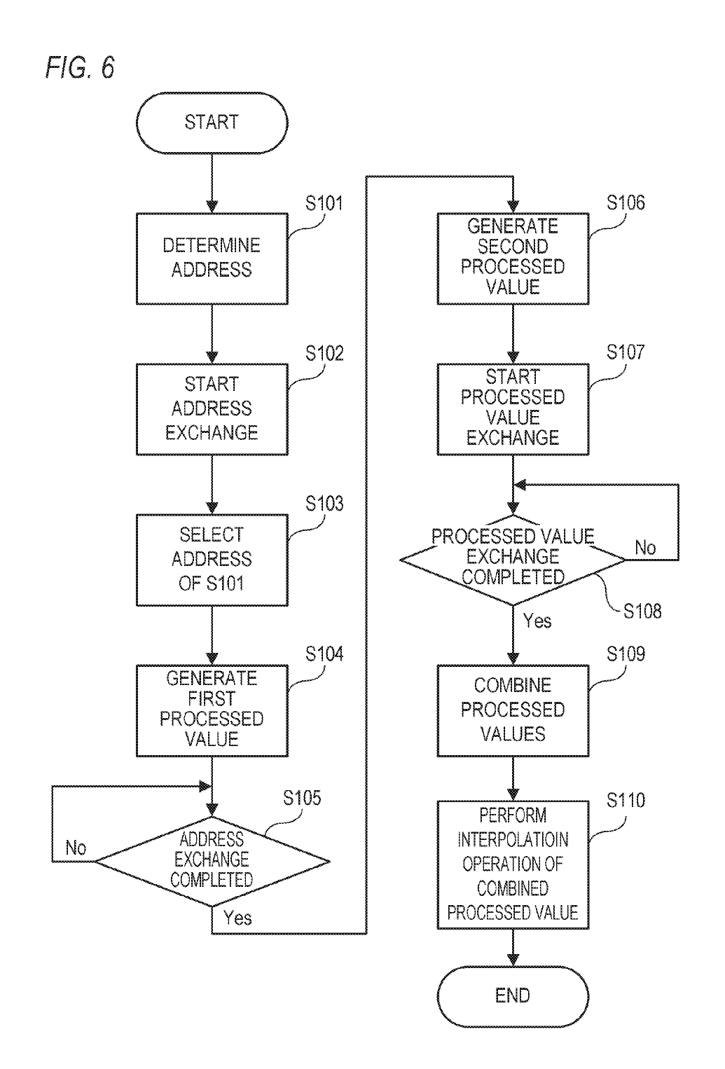

Next, an example of a processing flow of an image processing system according to the present embodiment will be described. FIG. 6 is a flow chart showing an example of a processing flow of an image processing system according to the present embodiment. Processing related to input image data that is input to the image processing apparatus 100 will now be described. Moreover, since processing related to the input image data that is input to the image processing apparatus 200 is similar to processing related to the input image data that is input to the image processing apparatus 100, a description thereof will be omitted.

First, in S101, the address determining unit 101 determines an address based on a pixel value of the input image data. The address determining unit 101 outputs the determined address to the address exchanging unit 102 and the address selecting unit 103.

Next, in S102, the address exchanging unit 102 starts communication (an address exchange) with the address exchanging unit 202 of the image processing apparatus 200. For example, a process by the address exchanging unit 102 of outputting the address determined in S101 to the address exchanging unit 202 is performed as the address exchange. The address exchange may include a process by the address exchanging unit 102 of acquiring an address output from the address exchanging unit 202 in addition to the process by the address exchanging unit 102 of outputting the address determined in S101 to the address exchanging unit 202. In the present embodiment, processes of S103 and S104 are performed in parallel to the execution of the address exchange. After the address exchange is completed, processing may be advanced to S103.

In S103, the address selecting unit 103 selects the address determined by the address determining unit 101 and outputs the selected address to the LUT 104. In other words, the address selecting unit 103 outputs the address determined in S101 to the LUT 104.

In S104, the LUT 104 outputs a first processed value dat1 corresponding to the address outputted by the address selecting unit 103 in S103 to the processed value combining unit 107 (generation of a first processed value dat1). The processed value combining unit 107 retains the input processed value until a combining process is completed.

Next, in S105, the address exchanging unit 202 of the image processing apparatus 200 determines whether or not the address exchange with the address exchanging unit 102 has been completed. For example, a determination that the address exchange has been completed is made in a case where a process by the address exchanging unit 202 of acquiring the address determined in S101 from the address exchanging unit 102 is completed. On the other hand, a determination that the address exchange has not been completed is made in a case where the process by the address exchanging unit 202 of acquiring the address determined in S101 from the address exchanging unit 102 has not been completed. The process of S105 is repeated until a determination that the address exchange has been completed is made, and once it is determined that the address exchange has been completed, the processing is advanced to S106.

In S106, the address exchanging unit 202 outputs the address determined in S101 to the LUT 204 via the address selecting unit 203. Accordingly, a second processed value dat2 corresponding to the address determined in S101 is generated at the LUT 204. In addition, the LUT 204 outputs the second processed value dat2 corresponding to the address determined in S101 to the processed value exchanging unit 206.

Next, in S107, the processed value exchanging unit 206 starts communication (a processed value exchange) with the processed value exchanging unit 106 of the image processing apparatus 100. For example, a process by the processed value exchanging unit 206 of outputting the second processed value dat2 obtained in S106 to the processed value exchanging unit 106 is performed as the processed value exchange. The processed value exchange may include a process by the processed value exchanging unit 206 of acquiring the first processed value dat1 output from the processed value exchanging unit 106 in addition to the process by the processed value exchanging unit 206 of outputting the second processed value dat2 obtained in S106 to the processed value exchanging unit 106.

Subsequently, in S108, the processed value exchanging unit 106 determines whether or not the processed value exchange with the processed value exchanging unit 206 has been completed. For example, a determination that the processed value exchange has been completed is made in a case where a process by the processed value exchanging unit 106 of acquiring the second processed value dat2 obtained in S106 from the processed value exchanging unit 206 is completed. On the other hand, a determination that the processed value exchange has not been completed is made in a case where a process by the processed value exchanging unit 106 of acquiring the second processed value dat2 obtained in S106 from the processed value exchanging unit 206 has not been completed. The process of S108 is repeated until a determination that the processed value exchange has been completed is made, and once it is determined that the processed value exchange has been completed, the processing is advanced to S109. In addition, in a case where it is determined that the processed value exchange has been completed, the processed value exchanging unit 106 outputs the second processed value dat2 obtained in S106 to the processed value combining unit 107.

In S109, the processed value combining unit 107 combines the first processed value dat1 input in S104 and the second processed value dat2 input in S108 together (a combining process). Accordingly, a combined processed value with a bit width of X-number of bits such as shown in FIG. 5 is obtained. The processed value combining unit 107 outputs the combined processed value to the processed value selecting unit 108.

Next, in S110, the processed value selecting unit 108 selects the output value of the processed value combining unit 107 and outputs the selected output value to the interpolating unit 109. In other words, the processed value selecting unit 108 outputs the combined processed value obtained in S109 to the interpolating unit 109. Subsequently, the interpolating unit 109 performs an interpolating operation of the combined processed value based on the pixel value of the input image data.

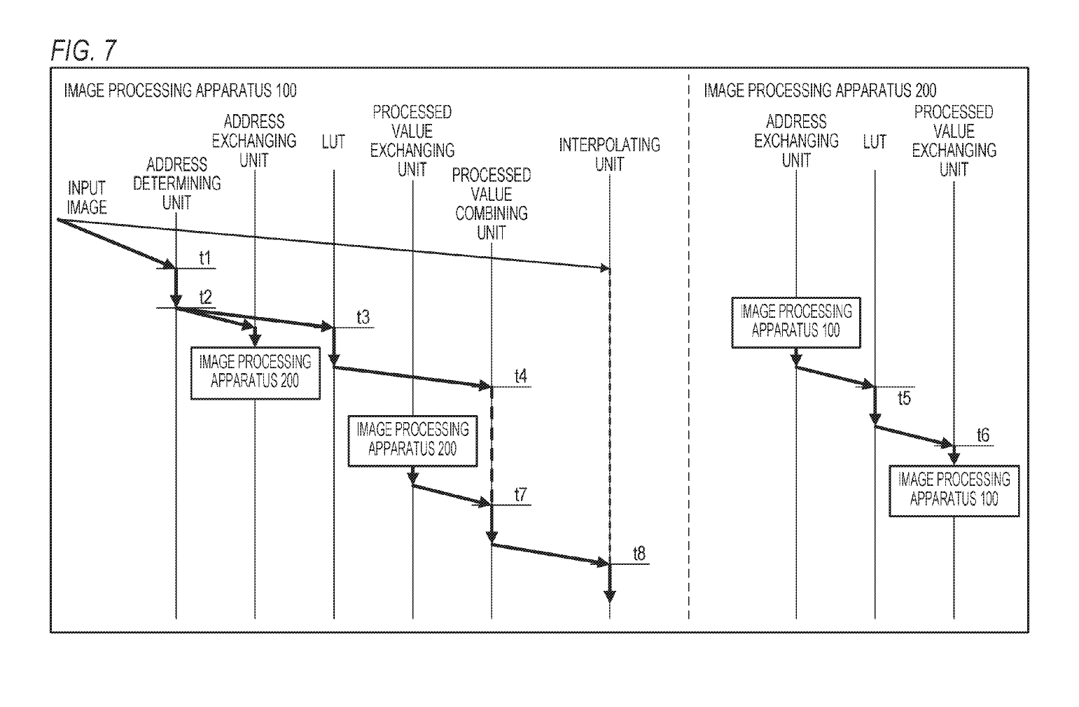

FIG. 7 is a time chart showing an example of processing timings of an image processing system according to the present embodiment. FIG. 7 is a time chart corresponding to the processing flow described with reference to FIG. 6.

At time t1, image data is input to the address determining unit 101 of the image processing apparatus 100 and determination of an address is started. Next, at time t2, the determination of an address is completed and the determined address is input to the address exchanging unit 102 and the LUT 104. Subsequently, at time t3, the LUT 104 reads a first processed value dat1 corresponding to the address determined at time t2. Next, at time t4, the read first processed value dat1 is input to the processed value combining unit 107. The first processed value dat1 input to the processed value combining unit 107 is retained by the processed value combining unit 107 until a combining process is completed.

At time t5, the LUT 204 reads a second processed value dat2 corresponding to the address input to the LUT 204 via the address exchanging unit 202 and the address selecting unit 203 from the address exchanging unit 102. Subsequently, the read second processed value dat2 is input to the processed value exchanging unit 206. In addition, at time t6, a process of outputting the read second processed value dat2 from the processed value exchanging unit 206 to the processed value exchanging unit 106 is started.

At time t7, the second processed value dat2 acquired by the processed value exchanging unit 106 from the processed value exchanging unit 206 is input to the processed value combining unit 107, and the input second processed value dat2 and the first processed value dat1 retained since time t4 are combined together.

Subsequently, at time t8, the interpolating unit 109 performs an interpolating operation of the combined processed value obtained by the processed value combining unit 107.

In this case, the processed value combining unit 107 needs to retain the first processed value dat1 input at time t4 until time t7. In addition, the interpolating unit 109 also needs to retain the pixel value of the input image data until a timing arrives at which an interpolating operation is performed. Although not illustrated, such retention can be realized using a delay circuit that uses a latch, a first in first out (FIFO) memory, a dynamic random access memory (DRAM), or the like.

Moreover, during a period in which the image processing apparatus 100 performs processing with respect to the input image data to the image processing apparatus 100, the image processing apparatus 200 may perform processing with respect to the input image data to the image processing apparatus 200. In such a case, the LUT 204 performs reading two times (two types of reading) including reading of a second processed value that corresponds to the address determined by the image processing apparatus 100 and reading of a second processed value that corresponds to the address determined by the image processing apparatus 200. Therefore, in such a case, the LUT 204 must be operated at a rate that is twice a rate of the input image data or higher. For example, by raising an operating frequency (operating speed) of the LUT 204 to twice an operating frequency of other functional units or higher, the LUT 204 can be operated at a rate that is twice the rate of the input image data or higher.

In addition, during a period in which the image processing apparatus 100 performs processing with respect to the input image data to the image processing apparatus 100, the LUT 104 may be used (referred to) by the image processing apparatus 200. In such a case, the LUT 104 must be operated at a rate that is twice the rate of the input image data or higher due to reasons similar to that described above.

As described above, according to the present embodiment, a highly accurate image processing result can be obtained without increasing cost of an image processing apparatus by operating a plurality of image processing apparatuses in cooperation with each other. Specifically, an image processing result equivalent to that of a case where an LUT performing highly accurate image processing is used can be obtained without increasing cost of an image processing apparatus. The image processing system according to the present embodiment is capable of accommodating highly accurate image processing with respect to HDR image data. Moreover, while an example where image processing is performed using an LUT has been described in the present embodiment, this example is not restrictive. Methods of performing image processing are not particularly limited. For example, image processing which converts a pixel value by an operation using a function may be performed.

### Second Embodiment

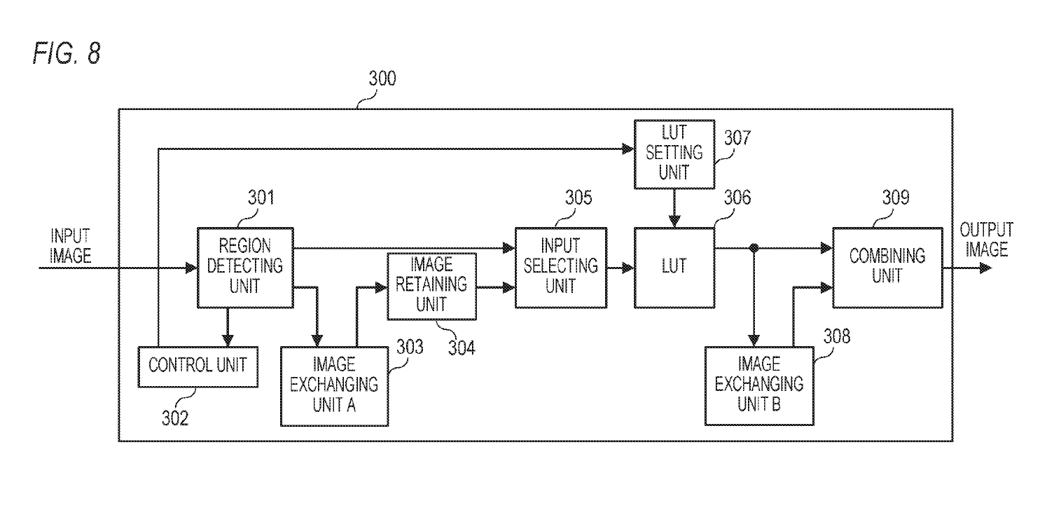

Hereinafter, an image processing apparatus and a control method thereof according to a second embodiment of the present invention will be described. FIG. 8 is a block diagram showing an example of a configuration of an image processing apparatus 300 according to the present embodiment.

A region detecting unit 301 distinguishes and detects a plurality of specific regions among regions of an image (an input image) represented by input image data. In the present embodiment, the region detecting unit 301 detects a first region and a second region among regions of the input image. In the present embodiment, the second region corresponds to ordinary display in which a brightness dynamic range takes a normal value. In addition, the first region corresponds to display (HDR display) with a wider brightness dynamic range than the display corresponding to the second region. In the present embodiment, the first region will be described as an “HDR region” and the second region will be described as an “ordinary region”. The region detecting unit 301 outputs the input image data with respect to a region including at least a region A1 that is one of an HDR region and an ordinary region to an input selecting unit 305. In addition, the region detecting unit 301 outputs the input image data with respect to a region including at least a region A2 that is the other of the HDR region and the ordinary region to an image exchanging unit A 303. In the present embodiment, the input image data with respect to the region A1 is output to the input selecting unit 305 and the input image data with respect to the region A2 is output to the image exchanging unit A 303. Hereinafter, the input image data with respect to the region A1 will be described as “image data D1” and the input image data with respect to the region A2 will be described as “image data D2”.

Moreover, the first region and the second region are not limited to the regions described above. For example, the first region may be a region containing a large amount of a first color and the second region may be a region containing a large amount of a second color. While the first color and the second color are not particularly limited, for example, the first color is an achromatic color and the second color is a chromatic color.

Moreover, methods of detecting a specific region are not particularly limited. For example, a specific region can be detected using several high order bits of each pixel value of the input image data. In addition, in a case where region information indicating a specific region is added to the input image data, the specific region can be detected by referring to the region information.

A control unit 302 determines which type of specific region is large based on types and sizes of the respective specific regions detected by the region detecting unit 301. In addition, the control unit 302 can communicate with other image processing apparatus and compare a type and a size of each specific region detected by the image processing apparatus 300 with a type and a size of each specific region detected by the other image processing apparatus.

The image exchanging unit A 303 communicates with the other image processing apparatus. Specifically, the image exchanging unit A 303 outputs image data D2 output from the region detecting unit 301 to the other image processing apparatus and acquires image data D3 from the other image processing apparatus.

An image retaining unit 304 retains (stores) the image data D3 acquired by the image exchanging unit A303 from the other image processing apparatus. The image data D3 retained by the image retaining unit 304 is read from the image retaining unit 304 by the input selecting unit 305 at a specific timing.

The input selecting unit 305 selects one of the image data D1 output from the region detecting unit 301 and the image data D3 retained by the image retaining unit 304 and outputs the selected image data to an LUT 306.

The LUT 306 is an LUT for performing first image processing. The LUT 306 outputs an output value corresponding to a pixel value of the image data input to the LUT 306 (a first processed value that is a pixel value after the first image processing). At the LUT 306, a process of converting a pixel value to the first processed value is performed for each pixel of the image data input to the LUT 306. At the LUT 306, the image data D1 may be subjected to the first image processing and the image data D3 may be subjected to the first image processing. Hereinafter, image data obtained by applying the first image processing to the image data D1 will be described as “processed image data PD1” and image data obtained by applying the first image processing to the image data D3 will be described as “processed image data PD3”. Moreover, an interpolating operation of the first processed value may be performed as described in the first embodiment.

An LUT setting unit 307 sets the LUT 306 so that image processing corresponding to the region A1 is performed as first image processing. “Setting an LUT” can be rephrased as “setting image processing”. For example, “a process of setting an LUT so that image processing corresponding to the region A1 is performed as the first image processing” can be rephrased as “a process of setting image processing corresponding to the region A1 as the first image processing”. In the present embodiment, the control unit 302 may select an HDR region as the region A1 or may select an ordinary region as the region A1. Therefore, in accordance with a selection result of the region A1, the LUT setting unit 307 switches the setting of the LUT 306 between an LUT for executing image processing corresponding to an HDR region and an LUT for executing image processing corresponding to an ordinary region. Specifically, the control unit 302 issues an instruction in accordance with the selection result of the region A1 to the LUT setting unit 307. In addition, the LUT setting unit 307 performs setting of the LUT 306 in accordance with the instruction from the control unit 302.

An image exchanging unit B 308 communicates with the other image processing apparatus. Specifically, the image exchanging unit B 308 outputs the processed image data PD3 obtained by the LUT 306 to the other image processing apparatus and acquires image data from the other image processing apparatus.

In the present embodiment, the other image processing apparatus has an LUT for performing second image processing which differs from the first image processing. The second image processing corresponds to a region A2. The LUT included in the other image processing apparatus will be hereinafter referred to as the “other LUT”. The image exchanging unit A 303 communicates with the other image processing apparatus to have the other LUT perform the second image processing on the input image data. Specifically, in a case where image data D2 output by the region detecting unit 301 is output from the image exchanging unit A 303 to the other image processing apparatus, the image data D2 output from the region detecting unit 301 is input to the other LUT. As a result, the second image processing is applied to the image data D2 output from the region detecting unit 301 by the other LUT. Therefore, “a process of having the other LUT perform the second image processing on the input image data” can be rephrased as “a process of having the other LUT perform the second image processing on the image data D2 output from the region detecting unit 301”. Hereinafter, image data obtained by applying the second image processing to the image data D2 will be described as “processed image data PD2”. In addition, by communicating with the other image processing apparatus, the image exchanging unit B 308 acquires the processed image data PD2 from the other image processing apparatus.

Alternatively, a single communicating unit having functions of the image exchanging unit A 303 and the image exchanging unit B 308 may be used in place of the image exchanging unit A 303 and the image exchanging unit B 308.

A combining unit 309 performs a combining process in which a result of the first image processing by the LUT 306 and a result of the second image processing acquired by the image exchanging unit B 308 are combined together. The combining process is a process of combining together a result of applying the first image processing to the input image data and a result of applying the second image processing to the input image data. In the present embodiment, the combining process is a process of combining the processed image data PD1 and the processed image data PD2 together. Therefore, as a result of the combining process, combined image data is generated which represents a combined image that is an image obtained by applying the first image processing to the region A1 of the input image and, at the same time, an image obtained by applying the second image processing to the region A2 of the input image. In addition, the processed value combining unit 107 outputs the combined image data.

Depending on a data capacity of an LUT included in an image processing apparatus, there may be cases where a plurality of LUTs corresponding to a plurality of types of image processing cannot be set at the same time. For example, there may be cases where, in a single image processing apparatus, only an LUT corresponding to the first image processing can be set and an LUT corresponding to the second image processing cannot be set. In such a case, although desired image processing can be applied to the region A1 of the input image, desired image processing cannot be applied to the region A2 of the input image and, consequently, image quality of image processing may deteriorate.

In consideration thereof, in the present embodiment, an increase in the number of LUTs used for image processing is achieved by using the other image processing apparatus. As a result, a highly accurate image processing result can be obtained without increasing cost of an image processing apparatus.

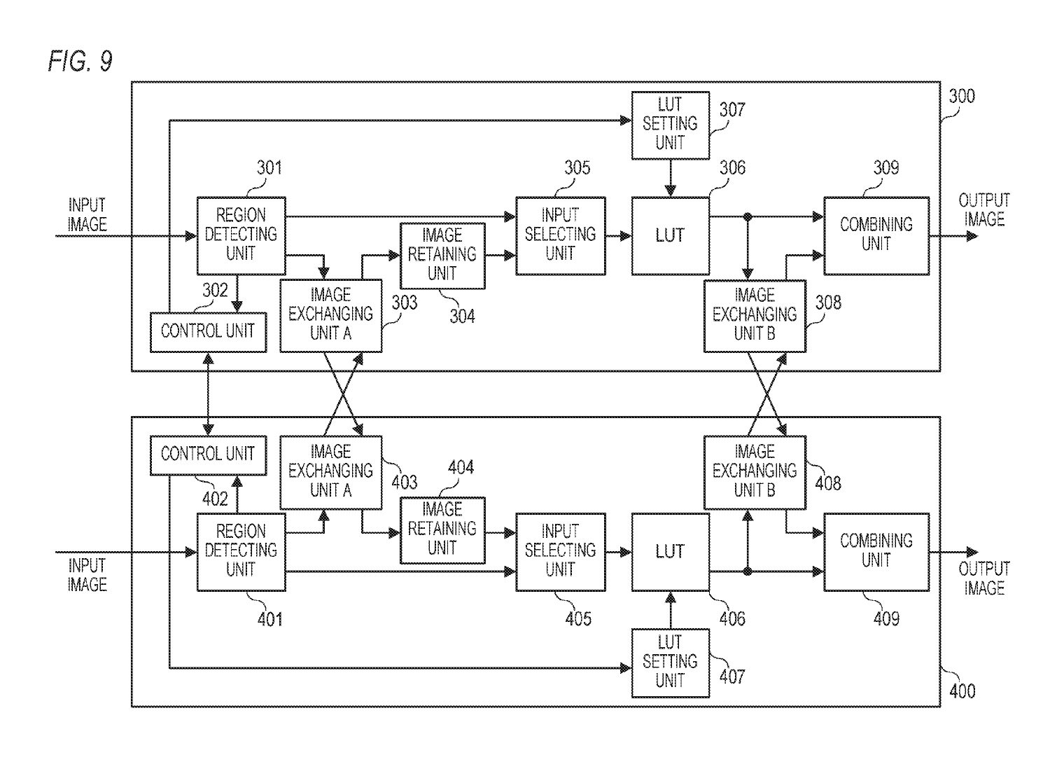

FIG. 9 is a block diagram showing an example of a configuration of an image processing system according to the present embodiment. As shown in FIG. 9, the image processing system according to the present embodiment includes the image processing apparatus 300 and an image processing apparatus 400. Alternatively, the image processing system may include three or more image processing apparatuses. The image processing apparatus 400 includes a region detecting unit 401, a control unit 402, an image exchanging unit A 403, an image retaining unit 404, an input selecting unit 405, an LUT 406, an LUT setting unit 407, an image exchanging unit B 408, and a combining unit 409.

The region detecting unit 401 has a similar function to the region detecting unit 301. The control unit 402 has a similar function to the control unit 302. The image exchanging unit A 403 has a similar function to the image exchanging unit A 303. The image retaining unit 404 has a similar function to the image retaining unit 304. The input selecting unit 405 has a similar function to the input selecting unit 305. The LUT 406 has a similar function to the LUT 306. The LUT setting unit 407 has a similar function to the LUT setting unit 307. The image exchanging unit B 408 has a similar function to the image exchanging unit B 308. In addition, the combining unit 409 has a similar function to the combining unit 309. In other words, the image processing apparatus 400 has a similar configuration to the image processing apparatus 300. The image processing apparatus 400 performs processing which may be described by replacing the term “first” in the description related to the processing by the image processing apparatus 300 provided above with the term “second” and by replacing the term “region A1” in the description related to the processing by the image processing apparatus 100 provided above with the term “region A2”.

In the present embodiment, communication is performed between the control unit 302 and the control unit 402 and the regions A1 and A2 are determined so that a data size of image data transmitted and received between the image processing apparatus 300 and the image processing apparatus 400 is reduced. In addition, setting of an LUT (setting of image processing) is performed in accordance with a determination result of the regions A1 and A2.

Specifically, in a case where an HDR region detected by the region detecting unit 301 is larger than an HDR region detected by the region detecting unit 401, an HDR region is selected as the region A1 and an ordinary region is selected as the region A2. As a result, an LUT for performing image processing corresponding to an HDR region is set as the LUT 306 and an LUT for performing image processing corresponding to an ordinary region is set as the LUT 406. In a case where the HDR region detected by the region detecting unit 301 is smaller than the HDR region detected by the region detecting unit 401, an ordinary region is selected as the region A1 and an HDR region is selected as the region A2. As a result, an LUT for performing image processing corresponding to an ordinary region is set as the LUT 306 and an LUT for performing image processing corresponding to an HDR region is set as the LUT 406.

Moreover, types of the regions A1 and A2 may be determined in advance by a manufacturer or may be set in accordance with a user operation. For example, an HDR region may always be used as the region A1 and an ordinary region may always be used as the region A2.

In addition, the communication for transmitting and receiving image data prior to image processing is performed between the image exchanging unit A 303 and the image exchanging unit A 403 and communication for transmitting and receiving image data after the image processing is performed between the image exchanging unit B 308 and the image exchanging unit B 408.

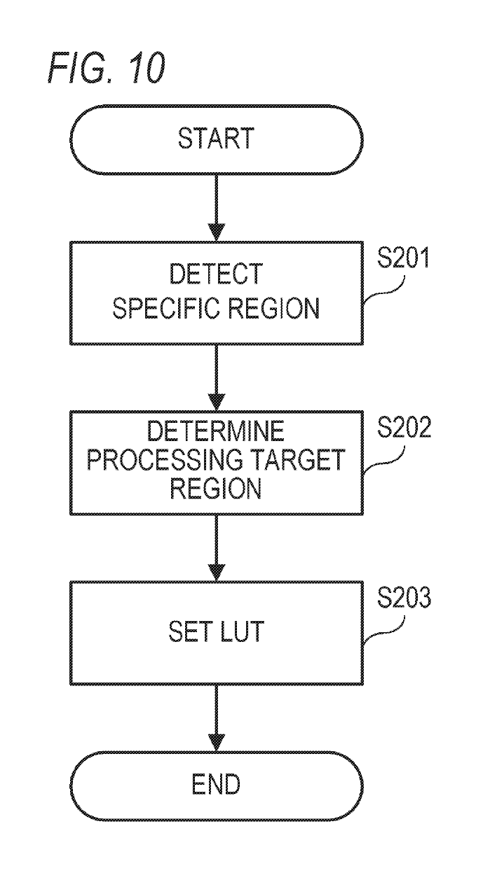

Next, an example of a processing flow of an LUT setting process (a process related to setting of an LUT) according to the present embodiment will be described. FIG. 10 is a flow chart showing an example of a processing flow of the LUT setting process according to the present embodiment.

First, in S201, the region detecting unit 301 of the image processing apparatus 300 distinguishes and detects a plurality of specific regions among regions of a first input image and notifies the control unit 302 of a type and a size of each specific region. In a similar manner, the region detecting unit 401 of the image processing apparatus 400 distinguishes and detects a plurality of specific regions among regions of a second input image and notifies the control unit 402 of a type and a size of each specific region. The first input image is an image represented by the input image data that is input to the image processing apparatus 300 and the second input image is an image represented by the input image data that is input to the image processing apparatus 400. In the present embodiment, an HDR region and an ordinary region are detected as the plurality of specific regions.

Next, in S202, communication is performed between the control unit 302 and the control unit 402. Accordingly, a processing target region of each image processing apparatus is determined in accordance with the detection result (a type and a size of each specific region) of S201. In the present embodiment, the regions A1 and A2 are determined. The determination of a processing target region may or may not be respectively performed by the control unit 302 and the control unit 402. The determination of a processing target region may be performed by one of the control unit 302 and the control unit 402 and a result of the determination may be notified from the one of the control unit 302 and the control unit 402 to the other.

Subsequently, in S203, the control unit 302 uses the LUT setting unit 307 to set an LUT in accordance with the processing result of S202 as the LUT 306. In a similar manner, the control unit 402 uses the LUT setting unit 407 to set an LUT in accordance with the processing result of S202 as the LUT 406.

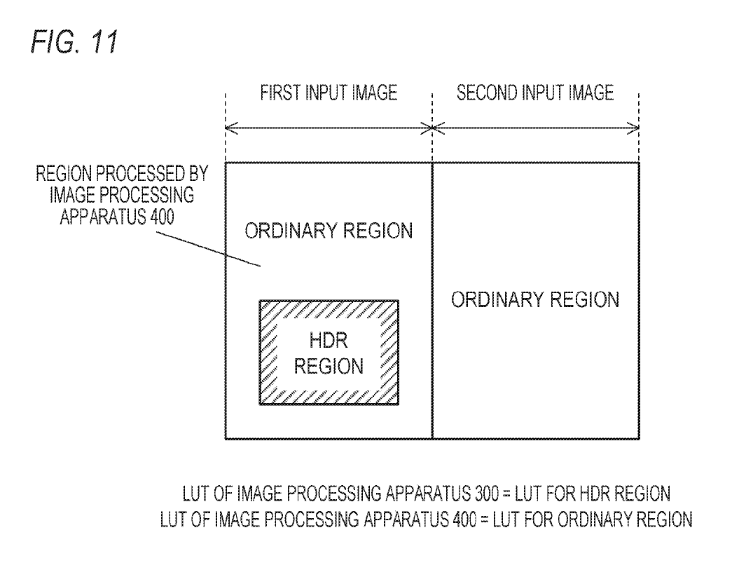

Specific examples of processes of S202 and S203 will now be described with reference to FIGS. 11 to 13. FIGS. 11 to 13 are diagrams showing examples of a first input image and a second input image. Moreover, while FIGS. 11 to 13 show two partial images constituting an original image as a first input image and a second input image, a first input image and a second input image are not limited to partial images. A first input image and a second input image may be two independent images that are independent of each other. In addition, while a size of a first input image is equal to a size of a second input image in FIGS. 11 to 13, the size of a first input image may differ from the size of a second input image.

FIG. 11 shows a case where an HDR region and an ordinary region are included in a first input image and only an ordinary region is included in a second input image. In this case, in S202, the HDR region is selected as the region A1 and the ordinary region is selected as the region A2. Subsequently, in S203, an LUT for performing image processing corresponding to the HDR region is set as the LUT 306 and an LUT for performing image processing corresponding to the ordinary region is set as the LUT 406.

In addition, in a case where the selection and settings described above are performed, the LUT 306 of the image processing apparatus 300 applies desired image processing (image processing corresponding to the HDR region) to the HDR region of the first input image. Furthermore, the LUT 406 of the image processing apparatus 400 applies desired image processing (image processing corresponding to the ordinary region) to the ordinary region of the first input image and to all of the regions of the second input image. In other words, desired image processing can be applied to all of the regions of the first input image and all of the regions of the second input image.

Let us now consider a case where the ordinary region is selected as the region A1 and the HDR region is selected as the region A2. In this case, an image corresponding to the HDR region of the first input image and the second input image (entire image) are to be transmitted and received between the image processing apparatus 300 and the image processing apparatus 400. On the other hand, in a case where the HDR region is selected as the region A1 and the ordinary region is selected as the region A2, an image corresponding to the ordinary region of the first input image is to be transmitted and received. A size of the ordinary region of the first input image is smaller than a sum of a size of the HDR region of the first input image and a size of the second input image (entire image). Therefore, by selecting the HDR region as the region A1 and selecting the ordinary region as the region A2, a data size of an image to be transmitted and received can be reduced.

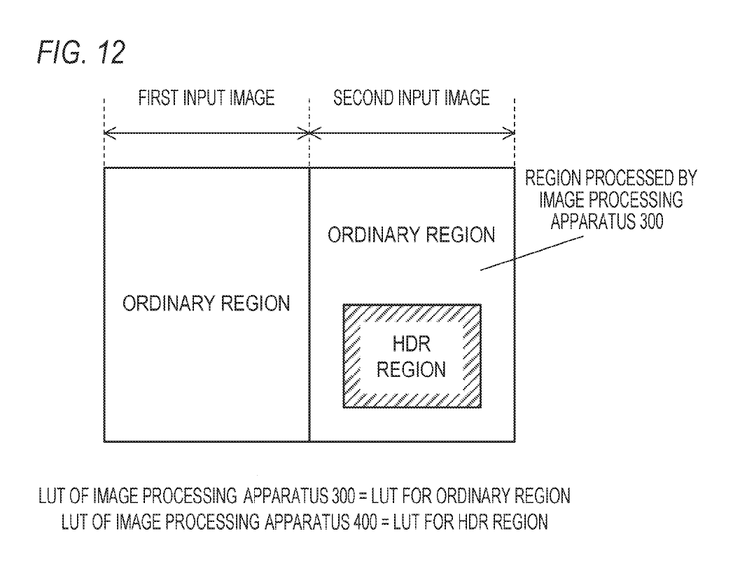

FIG. 12 shows a case where only an ordinary region is included in a first input image and an HDR region and an ordinary region are included in a second input image. In this case, in S202, the ordinary region is selected as the region A1 and the HDR region is selected as the region A2. Subsequently, in S203, an LUT for performing image processing corresponding to the ordinary region is set as the LUT 306 and an LUT for performing image processing corresponding to the HDR region is set as the LUT 406.

In addition, in a case where the selection and settings described above are performed, the LUT 306 of the image processing apparatus 300 applies desired image processing (image processing corresponding to the ordinary region) to all of the regions of the first input image and to the ordinary region of the second input image. Furthermore, the LUT 406 of the image processing apparatus 400 applies desired image processing (image processing corresponding to the HDR region) to the HDR region of the second input image. In other words, desired image processing can be applied to all of the regions of the first input image and all of the regions of the second input image.

Let us now consider a case where the HDR region is selected as the region A1 and the ordinary region is selected as the region A2. In this case, the first input image (entire image) and an image corresponding to the HDR region of the second input image are to be transmitted and received between the image processing apparatus 300 and the image processing apparatus 400. On the other hand, in a case where the ordinary region is selected as the region A1 and the HDR region is selected as the region A2, an image corresponding to the ordinary region of the second input image is to be transmitted and received. A size of the ordinary region of the second input image is smaller than a sum of a size of the first input image (entire image) and a size of the HDR region of the second input image. Therefore, by selecting the ordinary region as the region A1 and selecting the HDR region as the region A2, a data size of an image to be transmitted and received can be reduced.

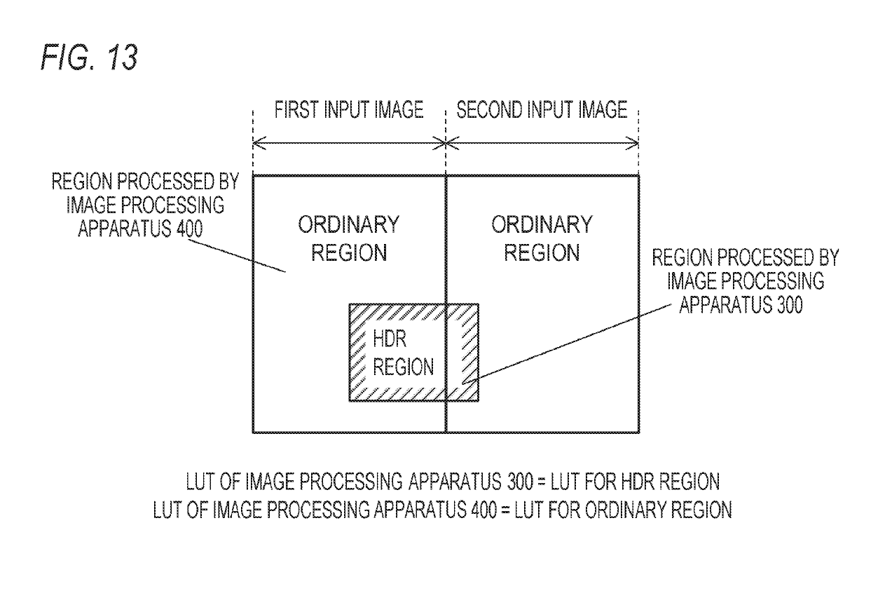

FIG. 13 shows a case where an HDR region and an ordinary region are included in a first input image and an HDR region and an ordinary region are also included in a second input image. The HDR region of the first input image is larger than the HDR region of the second input image. In this case, in S202, the HDR region is selected as the region A1 and the ordinary region is selected as the region A2. Subsequently, in S203, an LUT for performing image processing corresponding to the HDR region is set as the LUT 306 and an LUT for performing image processing corresponding to the ordinary region is set as the LUT 406.

In addition, in a case where the selection and settings described above are performed, the LUT 306 of the image processing apparatus 300 applies desired image processing (image processing corresponding to the HDR region) to the HDR region of the first input image and to the HDR region of the second input image. Furthermore, the LUT 406 of the image processing apparatus 400 applies desired image processing (image processing corresponding to the ordinary region) to the ordinary region of the first input image and to the ordinary region of the second input image. In other words, desired image processing can be applied to all of the regions of the first input image and all of the regions of the second input image.

Let us now consider a case where the ordinary region is selected as the region A1 and the HDR region is selected as the region A2. In this case, an image corresponding to the HDR region of the first input image and an image corresponding to the ordinary region of the second input image are to be transmitted and received between the image processing apparatus 300 and the image processing apparatus 400. On the other hand, in a case where the HDR region is selected as the region A1 and the ordinary region is selected as the region A2, an image corresponding to the ordinary region of the first input image and an image corresponding to the HDR region of the second input image are to be transmitted and received. A sum of a size of the ordinary region of the first input image and a size of the HDR region of the second input image is smaller than a sum of a size of the HDR region of the first input image and a size of the ordinary region of the second input image. Therefore, by selecting the HDR region as the region A1 and selecting the ordinary region as the region A2, a data size of an image to be transmitted and received can be reduced.

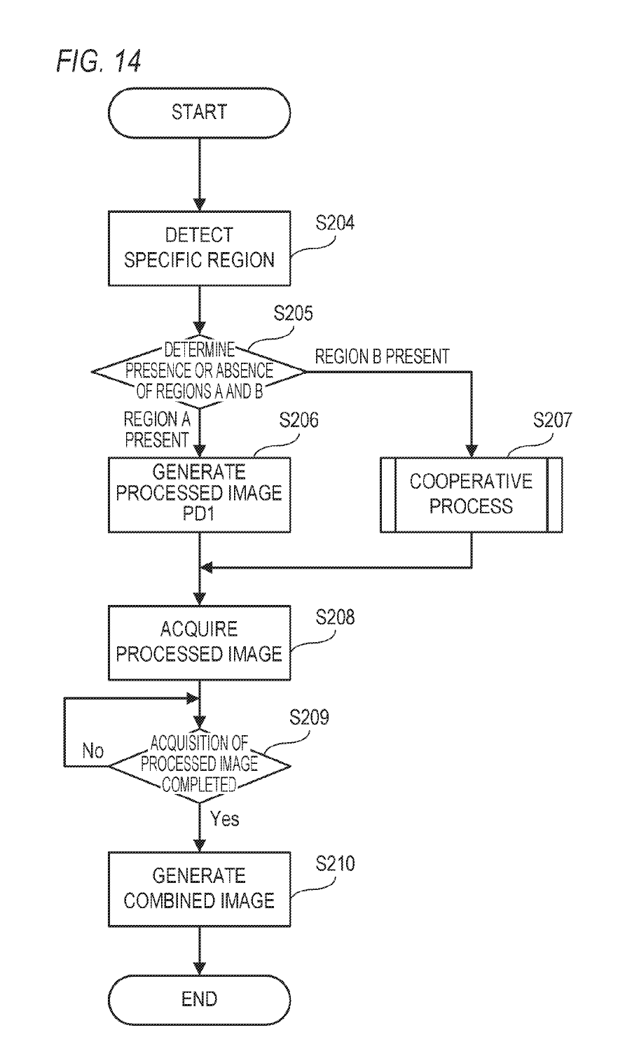

Next, an example of an overall processing flow of an image processing system according to the present embodiment will be described. FIG. 14 is a flow chart showing an example of an overall processing flow of an image processing system according to the present embodiment. Processing related to the input image data that is input to the image processing apparatus 300 will now be described. Moreover, since processing related to the input image data that is input to the image processing apparatus 400 is similar to processing related to the input image data that is input to the image processing apparatus 300, a description thereof will be omitted. The input image data that is input to the image processing apparatus 300 represents a first input image and the input image data that is input to the image processing apparatus 400 represents a second input image.

First, in S204, the region detecting unit 301 distinguishes and detects a plurality of specific regions among regions of the first input image. The process of S204 is the process of S201 already described. After the process of S204 (S201), the process of S202 and the process of S203 are performed and an advance is made to the process of S205. In a case where types and sizes of regions are the same, processes of S202 and S203 can be omitted.

In S205, the region detecting unit 301 determines whether or not the region A1 (a specific region to be processed by the image processing apparatus 300) has been detected among the regions of the first input image. In a case where the region A1 has been detected, the region detecting unit 301 outputs image data D1 that is the input image data with respect to the region A1 to the input selecting unit 305 and the process of S206 is performed. In addition, the region detecting unit 301 determines whether or not the region A2 (a specific region to be processed by the image processing apparatus 400) has been detected among the regions of the first input image. In a case where the region A2 has been detected, the region detecting unit 301 outputs image data D2 that is the input image data with respect to the region A2 to the image exchanging unit A 303 and the process of S207 is performed. In a case where both the region A1 and the region A2 have been detected, the process of S206 and the process of S207 are to be performed in parallel or in sequence.

In S206, the input selecting unit 305 outputs the image data D1 output from the region detecting unit 301 in S205 to the LUT 306. Accordingly, at the LUT 306, first image processing (image processing corresponding to the region A1) is applied to the image data D1 and processed image data PD1 is generated.

In S207, a cooperative process using the image processing apparatus 400 is performed. In the cooperative process, second image processing (image processing corresponding to the region A2) is applied to the image data D2 output by the region detecting unit 301 in S205 and processed image data PD2 is generated. In the cooperative process, the image exchanging unit A 303 outputs the image data D2 to the image processing apparatus 400 and the image exchanging unit B 308 acquires the processed image data PD2 from the image processing apparatus 400.

Subsequently, in S208, the combining unit 309 acquires processed image data necessary for a combining process. In a case where the region A1 is detected among the regions of the first input image and the region A2 is not detected among the regions of the first input image, the combining unit 309 acquires the processed image data PD1 generated in S206 from the LUT 306. In a case where the region A1 is not detected among the regions of the first input image and the region A2 is detected among the regions of the first input image, the combining unit 309 acquires the processed image data PD2 generated in S207 from the image exchanging unit B 308. In a case where both the region A1 and the region A2 are detected among the regions of the first input image, the combining unit 309 acquires both the processed image data PD1 and the processed image data PD2. In this case, there is no guarantee that the combining unit 309 acquires both the processed image data PD1 and the processed image data PD2 at the same time. The combining unit 309 retains acquired processed image data.

Next, in S209, the combining unit 309 determines whether or not all processed image data necessary for a combining process has been acquired. In a case where there is processed image data that has not been acquired, processing is returned to S208. In a case where all processed image data necessary for a combining process has been acquired, processing is advanced to S210.

In S210, the combining unit 309 generates combined image data by performing a combining process using the processed image data acquired in S208. In addition, the combining unit 309 outputs the generated combined image data. In a case where the region A1 is detected among the regions of the first input image and the region A2 is not detected among the regions of the first input image, the combining unit 309 outputs the processed image data PD1 as the combined image data. In a case where the region A1 is not detected among the regions of the first input image and the region A2 is detected among the regions of the first input image, the combining unit 309 outputs the processed image data PD2 as the combined image data. In a case where both the region A1 and the region A2 are detected among the regions of the first input image, the combining unit 309 outputs combined image data obtained by combining the processed image data PD1 and the processed image data PD2 together.

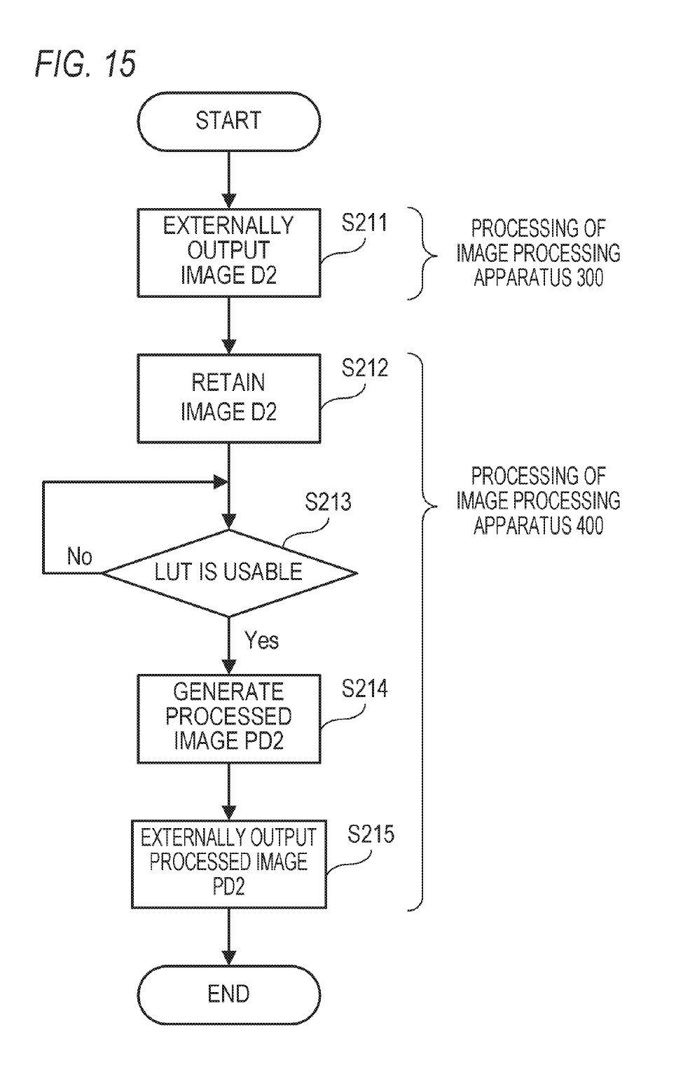

Next, an example of a processing flow of the process of S207 (a cooperative process) will be described. FIG. 15 is a flow chart showing an example of a processing flow of a cooperative process.

First, in S211, the image exchanging unit A 303 of the image processing apparatus 300 outputs the image data D2 output from the region detecting unit 301 in S205.

Next, in S212, the image exchanging unit A 403 of the image processing apparatus 400 acquires the image data D2 output from the image exchanging unit A 303 in S211 and outputs the acquired image data D2 to the image retaining unit 404. Accordingly, the image data D2 output from the image exchanging unit A 303 in S211 is retained by the image retaining unit 404.

Subsequently, in S213, the input selecting unit 405 determines whether or not a present timing is a timing at which the LUT 406 can be used. In a case where it is determined that the present timing is not a timing at which the LUT 406 can be used, the process of S213 is repeated until the present timing is determined to be a timing at which the LUT 406 can be used. In addition, in a case where it is determined that the present timing is a timing at which the LUT 406 can be used, processing is advanced to S214.

In S214, the input selecting unit 405 reads the image data D2 retained in S212 from the image retaining unit 404 and outputs the read image data D2 to the LUT 406. Accordingly, at the LUT 406, second image processing (image processing corresponding to the region A2) is applied to the image data D2 and processed image data PD2 is generated.

A timing at which the LUT 406 can be used is a timing within a period in which the LUT 406 is not performing processing. For example, a timing at which the LUT 406 can be used is a timing within a blank period in which the input image data is not being input to the image processing apparatus 400. In addition, a timing within a period in which the region B is not being detected by the region detecting unit 401 is also a timing at which the LUT 406 can be used. A case where the LUT 406 is capable of operating at a clock rate that is twice a clock rate of other functional units or higher will now be considered. In this case, a rising edge of a clock of the LUT 406 and a falling edge of the clock of the LUT 406 can be detected and processing by the LUT 406 can be multiplexed by time division. For example, in a case where the rising edge of the clock of the LUT 406 is detected, the input selecting unit 405 outputs image data from the region detecting unit 401 to the LUT 406. In addition, in a case where the falling edge of the clock of the LUT 406 is detected, the input selecting unit 405 outputs image data retained by the image retaining unit 404 to the LUT 406. Accordingly, processing by the LUT 406 is multiplexed by time division. In this case, the timing at which the falling edge of the clock of the LUT 406 is detected is also determined in S213 to be a timing at which the LUT 406 can be used.

Next, in S215, the LUT 406 outputs the processed image data PD2 generated in S214 to the image exchanging unit B 408. Subsequently, the image exchanging unit B 408 outputs the acquired processed image data PD2 to the image exchanging unit B 308.

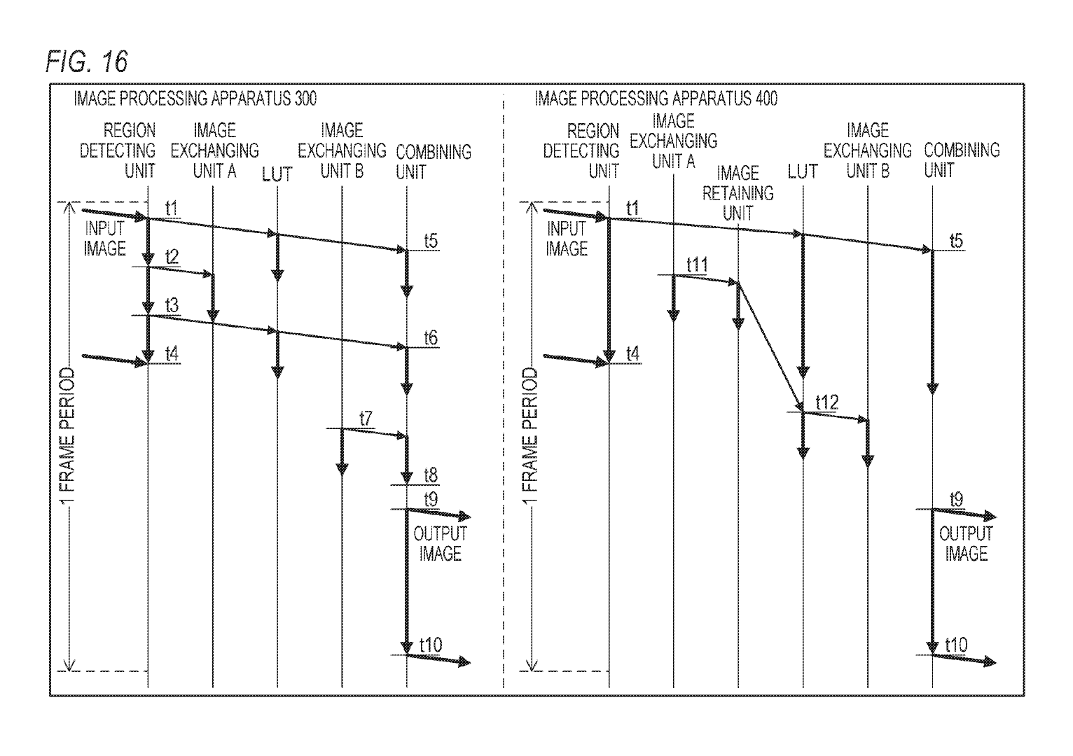

FIG. 16 is a time chart showing an example of processing timings of an image processing system according to the present embodiment. FIG. 16 is a time chart corresponding to the processing flow described with reference to FIGS. 14 and 15. In the example shown in FIG. 16, during a period from time t1 to time t4, images are input to both the image processing apparatus 300 and the image processing apparatus 400 and, during a period from time t9 to time t10, images are output from both the image processing apparatus 300 and the image processing apparatus 400. In FIG. 16, it is assumed that the region A1 and the region A2 are determined in advance. Moreover, a timing at which an image is input to the image processing apparatus 300 may differ from a timing at which an image is input to the image processing apparatus 400. A timing at which an image is output from the image processing apparatus 300 may differ from a timing at which an image is output from the image processing apparatus 400.

In the example shown in FIG. 16, the region detecting unit 301 determines that an image D1-1 input to the image processing apparatus 300 during a period from time t1 to time t2 and an image D1-2 input to the image processing apparatus 300 during a period from time t3 to time t4 are, respectively, images of the region A. The region A is a region to be processed by the image processing apparatus 300. Subsequently, the first image processing is applied to the images D1-1 and D1-2 by the LUT 306. A processed image PD1-1 is generated by applying the first image processing to the image D1-1 and a processed image PD1-2 is generated by applying the first image processing to the image D1-2. The processed image PD1-1 is input to the combining unit 309 at time t5 and the processed image PD1-2 is input to the combining unit 309 at time t6. In addition, the processed images PD1-1 and PD1-2 are retained by the combining unit 309.

Furthermore, the region detecting unit 301 determines that an image D2 input to the image processing apparatus 300 during a period from time t2 to time t3 is an image of the region B. The region B is a region to be processed by the image processing apparatus 400. Subsequently, the image D2 is output to the image processing apparatus 400 by the image exchanging unit A 303.

On the other hand, the region detecting unit 401 determines that an image D4 (entire image) input to the image processing apparatus 400 during a period from time t1 to time t4 is an image of the region B. Subsequently, the second image processing is applied to the image D4 by the LUT 406. A processed image PD4 is generated by applying the second image processing to the image D4. The processed image PD4 is input to the combining unit 409 at time t5. In addition, the processed image PD4 is retained by the combining unit 409.

In this case, the image D2 output from the image processing apparatus 300 is input to the image exchanging unit A 403 of the image processing apparatus 400 at time t11 and retained by the image retaining unit 404. However, this timing is a timing within a period in which the LUT 406 is performing processing on the image D4 and is not a timing at which the LUT 406 can be used for processing on the image D2. Therefore, the input selecting unit 405 awaits a timing at which the LUT 406 can be used for processing on the image D2. In addition, the input selecting unit 405 reads the image D2 from the image retaining unit 404 at time t12 within a blank period in which input of an image to the image processing apparatus 400 is not performed and outputs the read image D2 to the LUT 406. Subsequently, the second image processing is applied to the image D2 by the LUT 406. A processed image PD2 is generated by applying the second image processing to the image D2. The processed image PD2 is output to the image processing apparatus 300 by the image exchanging unit B 408.

In addition, the processed image PD2 is input to the image exchanging unit B 308 of the image processing apparatus 300 at time t7 and the image exchanging unit B 308 outputs the processed image PD2 to the combining unit 309. Subsequently, a combining process by the combining unit 309 is performed before time t9 and, at time t9, images are output from the combining unit 309 of the image processing apparatus 300 and the combining unit 409 of the image processing apparatus 400. A combined image obtained by combining the processed images PD1-1, PD1-2, and PD2 together is output from the combining unit 309 and the processed image PD4 is output from the combining unit 409.

In a case where the series of processes described above can be completed within one frame period of an input image, an input image of each frame can be processed without incident. In addition, in a case where the combining unit 309 includes a configuration capable of retaining images of a plurality of frames, an input image of a next frame can be processed without having to wait for image output by the combining unit 309 to be completed.

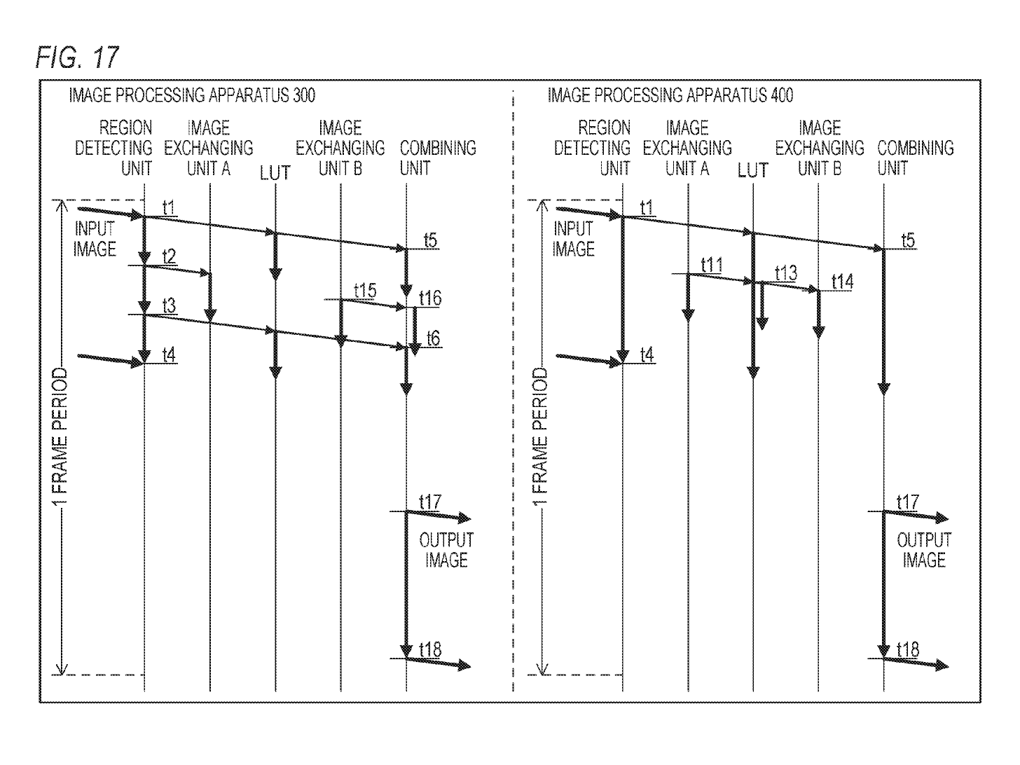

FIG. 17 is also a time chart corresponding to the processing flow described with reference to FIGS. 14 and 15. FIG. 17 presents a case where the LUT 406 is capable of operating at a clock rate that is twice a clock rate of other functional units or higher and processing of the LUT 406 is multiplexed by time division.

In the example shown in FIG. 17, since processing of the LUT 406 has been multiplexed by time division, at time t11 at which the image D2 output from the image processing apparatus 300 is input to the image exchanging unit A 403 of the image processing apparatus 400, the LUT 406 can be used for processing with respect to the image D2. Therefore, the image retaining unit 404 is substantially unnecessary. The image retaining unit 404 is omitted in FIG. 17.

In the example shown in FIG. 17, the image D2 is input to the LUT 406 at time t13 which precedes time t12 shown in FIG. 16. Subsequently, at time t14, the processed image PD2 is output from the image exchanging unit B 408 to the image processing apparatus 300.

In addition, the processed image PD2 is input to the image exchanging unit B 308 of the image processing apparatus 300 at time t15 which precedes time t7 shown in FIG. 16 and the processed image PD2 is input to the combining unit 309 at time t16. Subsequently, a combining process by the combining unit 309 is performed before time t17 and, during a period from time t17 to time t18, images are output from the combining unit 309 of the image processing apparatus 300 and the combining unit 409 of the image processing apparatus 400.

In FIG. 17, the processed image PD2 is input to the image processing apparatus 300 at time t15 which precedes time t7 shown in FIG. 16. Therefore, a time preceding time t9 shown in FIG. 16 can be set as time t17. In other words, a period from input to output of an image with respect to an image processing apparatus can be shortened to a period that is shorter than that shown in FIG. 16. As a result, an image with a short single frame period can be processed without incident.

Moreover, there is a method referred to as frame interleaving in which image processing is performed every several pixels with respect to one image (frame) and image processing with respect to all pixel positions is realized by image processing with respect to a plurality of frames. A region to which image processing is applied in the present embodiment may be a plurality of regions to be individually processed by frame interleaving (a plurality of regions with mutually different pixel combinations). In addition, each LUT may individually store a table value for each region to be processed by frame interleaving.

As described above, according to the present embodiment, a highly accurate image processing result can be obtained without increasing cost of an image processing apparatus by operating a plurality of image processing apparatuses in cooperation with each other. Specifically, an image processing result equivalent to that of a case where a plurality of types of LUTs are used can be obtained without increasing cost of an image processing apparatus.

### Third Embodiment

Hereinafter, an image processing apparatus and a control method thereof according to a third embodiment of the present invention will be described. With image processing that refers to an LUT, there are cases where two processed values respectively corresponding to two addresses which include an even address and an odd address and which are adjacent to each other are read from the LUT and an intermediate value of the two processed values is obtained by an interpolating operation. The present embodiment presents an example of an image processing system that is capable of performing such image processing with higher accuracy by having a plurality of image processing apparatuses cooperate with each other.

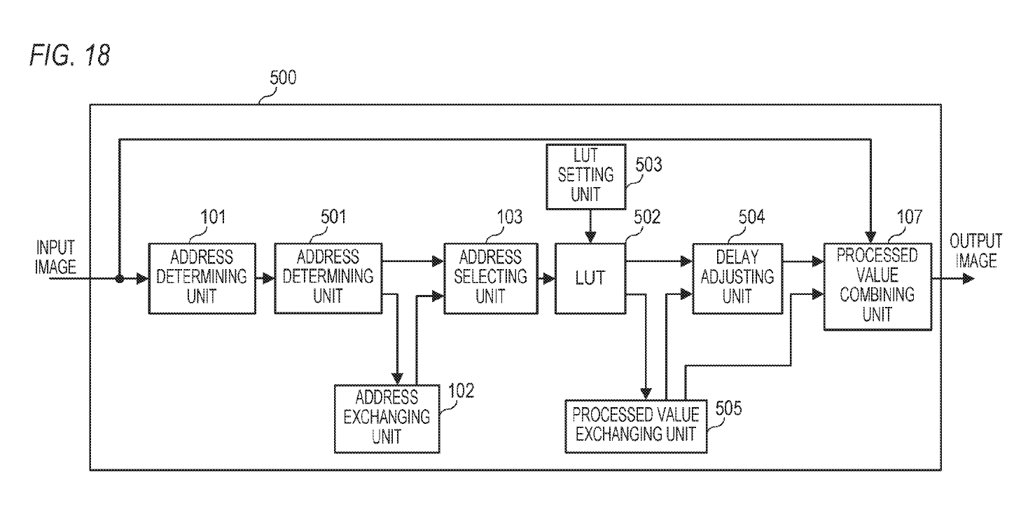

FIG. 18 is a block diagram showing an example of a configuration of an image processing apparatus 500 according to the present embodiment. Functional units equivalent to the functional units described in the embodiments presented above will be denoted by the same reference characters and detailed descriptions thereof will be omitted.

An address determining unit 501 selects the address exchanging unit 102 or the address selecting unit 103 in accordance with an attribute of an address determined by the address determining unit 101. In addition, the address determining unit 501 outputs the address determined by the address determining unit 101 to the selected functional unit. Moreover, all addresses may be output to one of the address exchanging unit 102 and the address selecting unit 103. In addition, the address determining unit 101 may determine two or more addresses with respect to one pixel of an input image. For example, with respect to one pixel, the address determining unit 101 may determine two addresses which include an even address and an odd address and which are adjacent to each other.

In a case of using the image processing apparatus 500 independently, a lookup table that is equivalent to the LUT 104 is used as an LUT 502 and an LUT setting unit 503 performs settings that are equivalent to the LUT setting unit 105. In a case of causing the image processing apparatus 500 to cooperate with other apparatus, the LUT setting unit 503 forms a lookup table that differs from the LUT 104 as the LUT 502.

A delay adjusting unit 504 is capable of retaining a processed value output from the LUT 502. As the delay adjusting unit 504, for example, a memory element such as a first in first out (FIFO) memory is used.

A processed value exchanging unit 505 has a similar function to the processed value exchanging unit 106. In addition, the processed value exchanging unit 505 can notify the delay adjusting unit 504 of a timing at which a processed value is received from other image processing apparatus. Accordingly, in synchronization with the timing at which a processed value is received from the other image processing apparatus, a processed value retained by the delay adjusting unit 504 can be read from the delay adjusting unit 504.

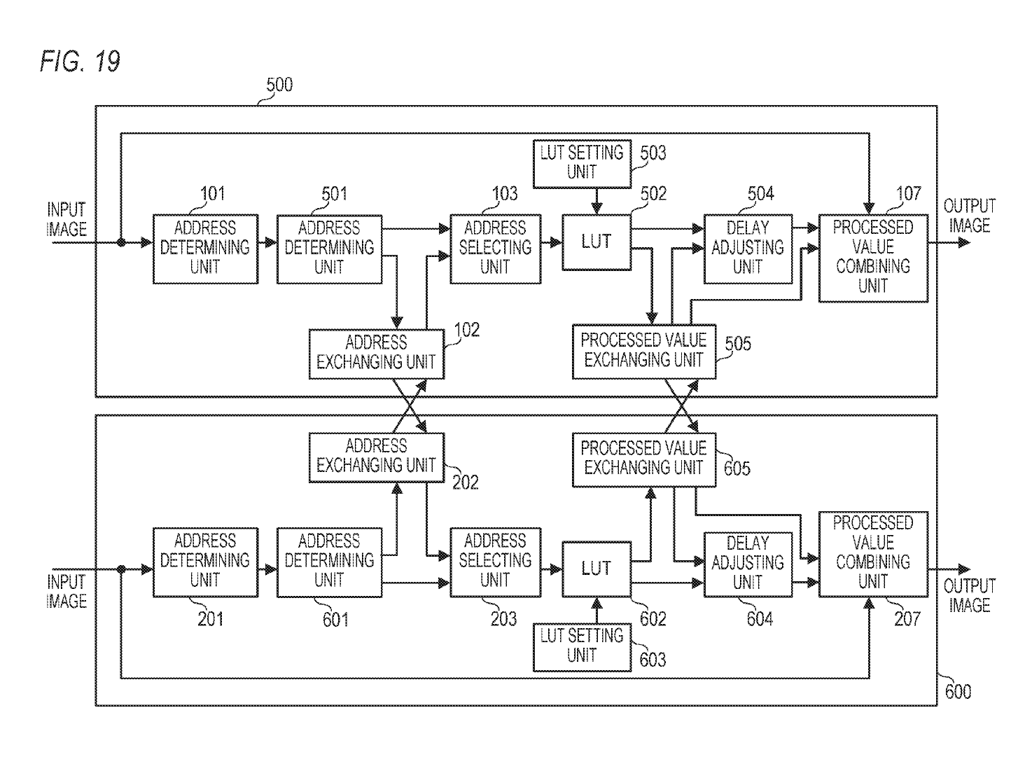

FIG. 19 is a block diagram showing an example of a configuration of an image processing system according to the present embodiment. As shown in FIG. 19, the image processing system according to the present embodiment includes the image processing apparatus 500 and an image processing apparatus 600. Alternatively, the image processing system may include three or more image processing apparatuses. The image processing apparatus 600 includes the address determining unit 201, an address determining unit 601, the address exchanging unit 202, the address selecting unit 203, an LUT 602, an LUT setting unit 603, a delay adjusting unit 604, a processed value exchanging unit 605, and the processed value combining unit 207.

The address determining unit 601 has a similar function to the address determining unit 501. The LUT 602 has a similar function to the LUT 502. The LUT setting unit 603 has a similar function to the LUT setting unit 503. The delay adjusting unit 604 has a similar function to the delay adjusting unit 504. The processed value exchanging unit 605 has a similar function to the processed value exchanging unit 505.

Communication for transmitting and receiving addresses is performed between the address exchanging unit 102 and the address exchanging unit 202 and communication for transmitting and receiving processed values is performed between the processed value exchanging unit 505 and the processed value exchanging unit 605.

Moreover, in the image processing system according to the present embodiment, the address determining unit 501 selects the address selecting unit 103 in a case where an address is even (even address) and selects the address exchanging unit 102 in a case where an address is odd (odd address). In a case where both an even address and an odd address are determined, both the address selecting unit 103 and the address exchanging unit 102 are selected, the even address is output to the address selecting unit 103, and the odd address is output to the address exchanging unit 102. In addition, the address determining unit 601 selects the address selecting unit 203 in a case where an address is an odd address and selects the address exchanging unit 202 in a case where an address is an even address. In a case where both an even address and an odd address are determined, both the address selecting unit 203 and the address exchanging unit 202 are selected, the odd address is output to the address selecting unit 203, and the even address is output to the address exchanging unit 202.

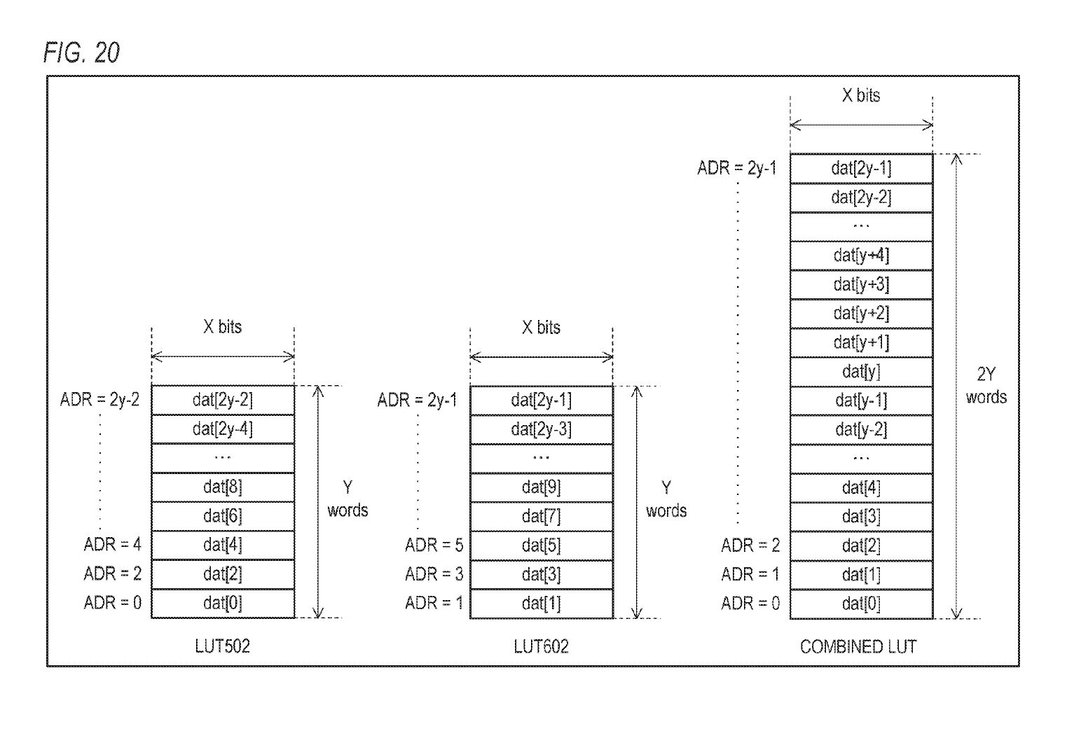

FIG. 20 shows an example of the LUT 502, the LUT 602, and a combined LUT obtained by combining the LUT 502 and the LUT 602 together. Processed values corresponding to even addresses are set in the LUT 502 and processed values corresponding to odd addresses are set in the LUT 602. In addition, in the present embodiment, the address determining unit 501 and the address determining unit 601 select an output destination of an address so that the LUT 502 is referred to in a case where an even address is determined and the LUT 602 is referred to in a case where an odd address is determined. Therefore, with the image processing system according to the present embodiment, image processing with higher accuracy can be performed as compared to a case where only one of the LUT 502 and the LUT 602 is used.

Moreover, processed values corresponding to odd addresses may be set in the LUT 502 and processed values corresponding to even addresses may be set in the LUT 602. In this case, the address determining unit 501 may select the address selecting unit 103 in a case where an address is an odd address and select the address exchanging unit 102 in a case where an address is an even address. The address determining unit 601 may select the address selecting unit 203 in a case where an address is an even address and select the address exchanging unit 202 in a case where an address is an odd address.

As described above, in the present embodiment, in synchronization with the timing at which the processed value exchanging unit 505 receives a processed value of the LUT 602, a processed value retained by the delay adjusting unit 504 can be read from the delay adjusting unit 504. Therefore, the processed value combining unit 107 can simultaneously use a processed value corresponding to an even address and a processed value corresponding to an odd address for an interpolating operation (a combining process).

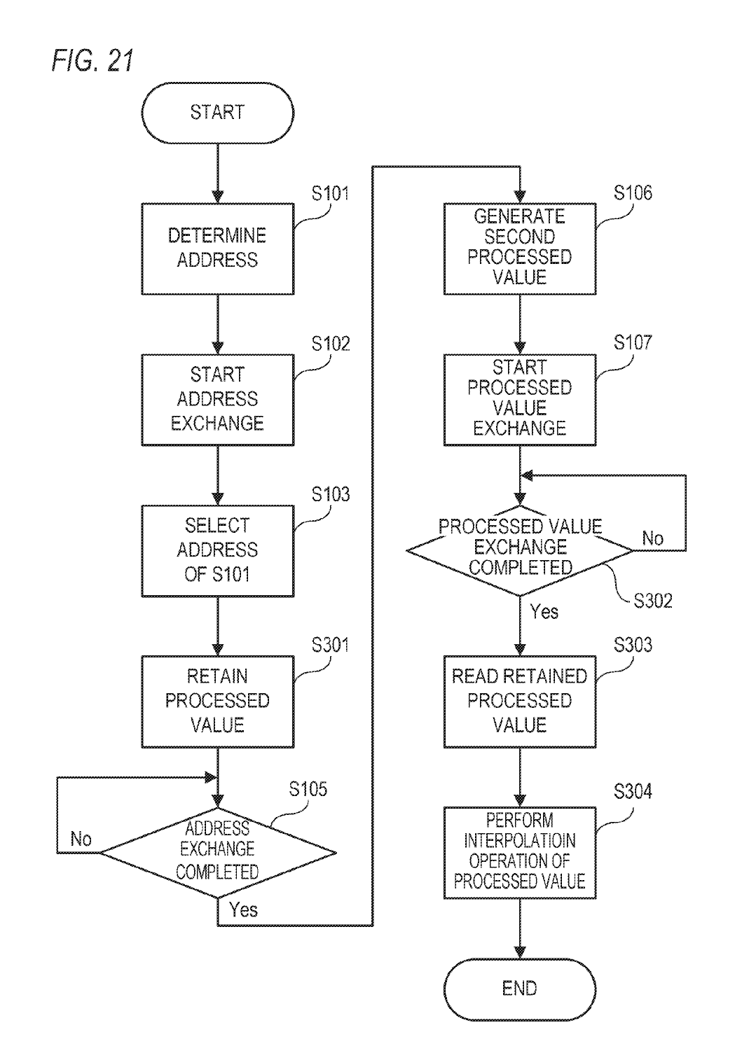

FIG. 21 is a flow chart showing an example of a processing flow of the present embodiment. Processes equivalent to the processes described in the embodiments presented above will be denoted by the same reference characters (step numbers) and detailed descriptions thereof will be omitted.

First, processes of S101 to S103 are performed. In this case, let us assume that both an even address and an odd address are determined in S101. Therefore, in S102, the address determining unit 501 outputs the odd address determined in S101 to the address exchanging unit 102 and the address exchanging unit 102 starts a process (address exchange) of outputting the odd address determined in S101 to the address exchanging unit 202. In addition, the address determining unit 501 outputs the even address determined in S101 to the address selecting unit 103. Subsequently, in S103, the address selecting unit 103 outputs the even address determined in S101 to the LUT 502. Accordingly, a processed value corresponding to the even address determined in S101 is output from the LUT 502 to the delay adjusting unit 504.

Next, in S301, the delay adjusting unit 504 acquires a processed value corresponding to the even address determined in S101 from the LUT 502 and retains the processed value. Subsequently, processes of S105 to S107 are performed. In S105, the address exchanging unit 202 of the image processing apparatus 600 determines whether or not a process (address exchange) of acquiring the odd address determined in S101 from the address exchanging unit 102 has been completed. In S106, the address exchanging unit 202 outputs the odd address determined in S101 to the LUT 602 via the address selecting unit 203. Accordingly, a processed value corresponding to the odd address determined in S101 is output from the LUT 602 to the processed value exchanging unit 605. In S107, the processed value exchanging unit 605 starts a process (processed value exchange) of outputting the processed value corresponding to the odd address determined in S101 to the processed value exchanging unit 505.

Subsequently, in S302, the processed value exchanging unit 505 determines whether or not the process (processed value exchange) of acquiring the processed value corresponding to the odd address determined in S101 from the processed value exchanging unit 605 has been completed. The process of S302 is repeated until the processed value exchange is completed. The processed value exchanging unit 505 notifies the delay adjusting unit 504 of a timing at which the processed value exchange is completed and processing is advanced to S303. In addition, in a case where the processed value exchange is completed, the processed value exchanging unit 505 outputs the processed value acquired from the processed value exchanging unit 605 (a processed value corresponding to the odd address determined in S101) to the processed value combining unit 107.

In S303, the delay adjusting unit 504 outputs the retained processed value (a processed value corresponding to the even address determined in S101) to the processed value combining unit 107 in synchronization with the notification performed in S302.

Subsequently, in S304, the processed value combining unit 107 performs an interpolating operation using the processed value output from the LUT 502 and the processed value output from the LUT 602. In other words, an interpolating operation using a processed value corresponding to the even address determined in S101 and a processed value corresponding to the odd address determined in S101 is performed. This interpolating operation can be rephrased as a “combining process of combining two processed values together”. In a case where only an even address is determined, only a processed value corresponding to the even address (the processed value output from the LUT 502) is used. In a case where only an odd address is determined, only a processed value corresponding to the odd address (the processed value output from the LUT 602) is used. Due to the interpolating operation of S304, pixel values of output image data are determined and output. Moreover, input image data may be used in the interpolating operation of S304 in a similar manner to the processing by the interpolating unit 109 according to the first embodiment.

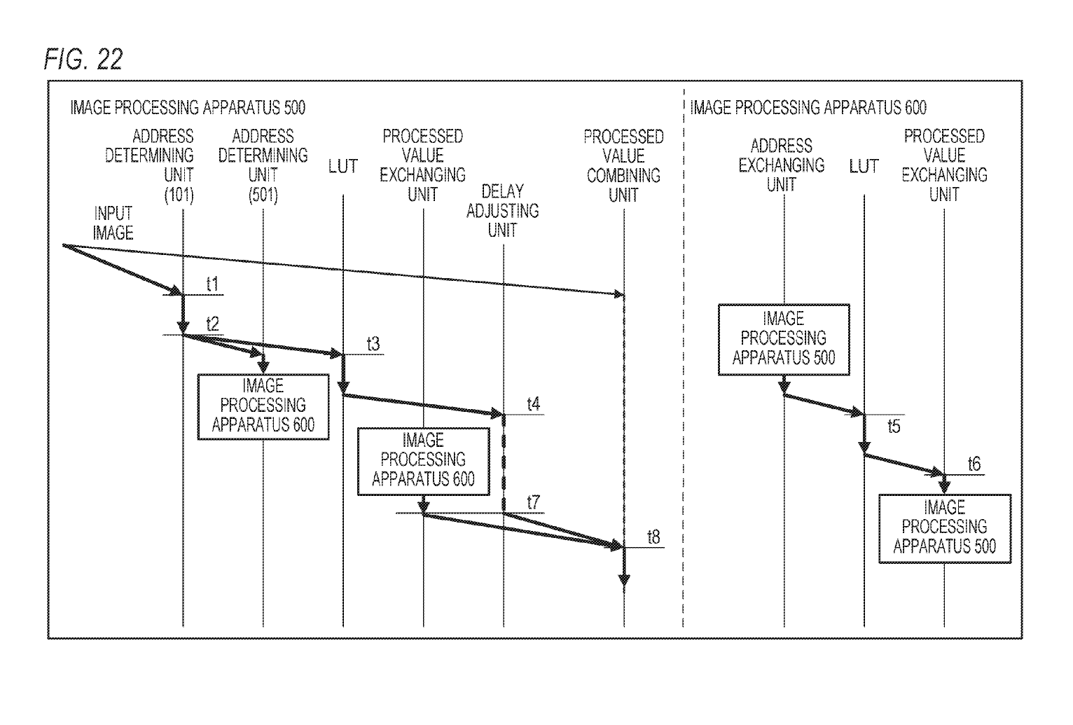

FIG. 22 is a time chart showing an example of processing timings of an image processing system according to the present embodiment. FIG. 22 is a time chart corresponding to the processing flow described with reference to FIG. 21.

At time t1, image data is input to the address determining unit 101 of the image processing apparatus 500 and determination of an address is started. Next, at time t2, the determination of an address is completed and the determined address is input to the address determining unit 501. In addition, the address determining unit 501 outputs an even address to the LUT 502 of the image processing apparatus 500 and outputs an odd address to the LUT 602 of the image processing apparatus 600. At time t3, a processed value corresponding to the even address output by the address determining unit 501 is read (output) by the LUT 502. At time t4, the processed value read at time t3 is input to and retained by the delay adjusting unit 504.

At time t5, the LUT 602 reads a processed value corresponding to the odd address input to the LUT 602 via the address exchanging unit 202 and the address selecting unit 203 from the address exchanging unit 102. Subsequently, the read processed value is input to the processed value exchanging unit 605. At time t6, a process of outputting the read processed value from the processed value exchanging unit 605 to the processed value exchanging unit 505 is started.

At time t7, a process by the processed value exchanging unit 505 of acquiring the processed value read by the LUT 602 is completed. At this point, a notification is made from the processed value exchanging unit 505 to the delay adjusting unit 504 and, in synchronization with the notification, a process of reading the processed value retained by the delay adjusting unit 504 (the processed value read by the LUT 502) from the delay adjusting unit 504 is started. At time t8, the processed value read by the LUT 502 and the processed value read by the LUT 602 are input to the processed value combining unit 107 and an interpolating operation is started.

Moreover, during a period in which the image processing apparatus 500 performs processing with respect to the input image data to the image processing apparatus 500, the image processing apparatus 600 may perform a process with respect to the input image data to the image processing apparatus 600. In such a case, the LUT 602 performs reading two times (two types of reading) including reading of a processed value that corresponds to the address determined by the image processing apparatus 500 and reading of a processed value that corresponds to the address determined by the image processing apparatus 600. Therefore, in such a case, the LUT 602 must be operated at a rate that is twice a rate of the input image data or higher. For example, by raising an operating frequency (operating speed) of the LUT 602 to twice an operating frequency of other functional units or higher, the LUT 602 can be operated at a rate that is twice the rate of the input image data or higher.

In addition, during a period in which the image processing apparatus 500 performs processing with respect to the input image data to the image processing apparatus 500, the LUT 502 may be used (referred to) by the image processing apparatus 600. In such a case, the LUT 502 must be operated at a rate that is twice the rate of the input image data or higher due to reasons similar to that described above.

As described above, according to the present embodiment, a highly accurate image processing result can be obtained without increasing cost of an image processing apparatus by operating a plurality of image processing apparatuses in cooperation with each other. Specifically, an image processing result equivalent to that of a case where an LUT performing highly accurate image processing is used can be obtained without increasing cost of an image processing apparatus. The image processing system according to the present embodiment is capable of accommodating highly accurate image processing with respect to HDR image data. Moreover, while an example where image processing is performed using an LUT has been described in the present embodiment, this example is not restrictive. Methods of performing image processing are not particularly limited. For example, image processing which converts a pixel value by an operation using a function can be performed.

### Fourth Embodiment

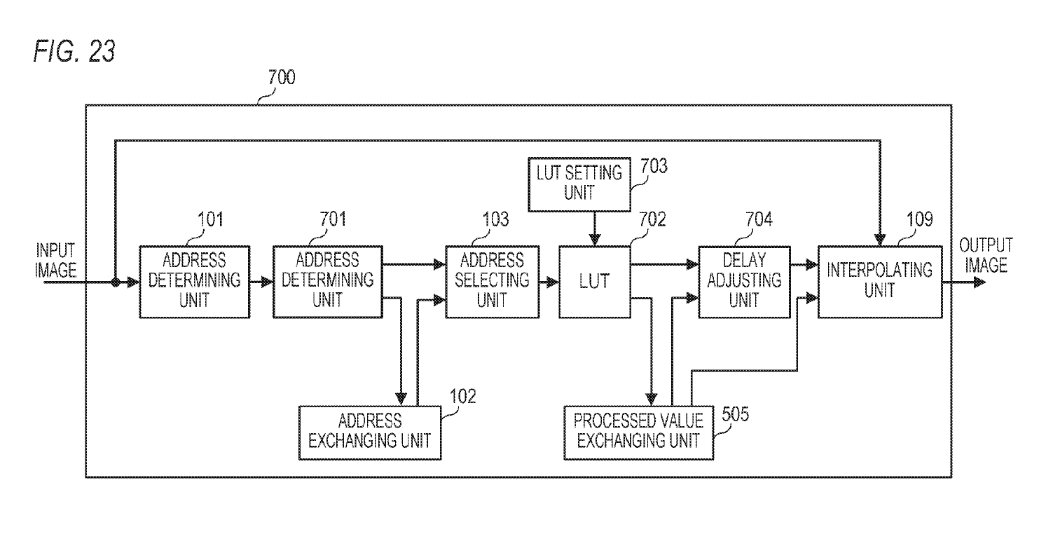

Hereinafter, an image processing apparatus and a control method thereof according to a fourth embodiment of the present invention will be described. FIG. 23 is a block diagram showing an example of a configuration of an image processing apparatus 700 according to the present embodiment. Functional units equivalent to the functional units described in the embodiments presented above will be denoted by the same reference characters and detailed descriptions thereof will be omitted.

An address determining unit 701 selects the address exchanging unit 102 or the address selecting unit 103 in accordance with an attribute of an address determined by the address determining unit 101. In addition, the address determining unit 701 outputs the address determined by the address determining unit 101 to the selected functional unit. Moreover, all addresses may be output to one of the address exchanging unit 102 and the address selecting unit 103. Furthermore, the address determining unit 701 determines an identification number corresponding to the address determined (the address used for processing) by the address determining unit 101. Subsequently, in a case where an address is output to the address selecting unit 103, the address determining unit 701 notifies a delay adjusting unit 704 (to be described later) of an identification number of the address.

In a case of using the image processing apparatus 700 independently, a lookup table that is equivalent to the LUT 104 is used as the LUT 702 and an LUT setting unit 703 performs settings that are equivalent to the LUT setting unit 105. In a case of causing the image processing apparatus 700 to cooperate with other apparatus, the LUT setting unit 703 forms a lookup table that differs from the LUT 104 as the LUT 702.

The delay adjusting unit 704 is capable of retaining a processed value output from the LUT 702. As the delay adjusting unit 704, for example, a memory element such as a first in first out (FIFO) memory is used. The delay adjusting unit 704 can control reading of a retained processed value based on the identification number from the address determining unit 701 and the notification from the processed value exchanging unit 505. Details thereof will be provided later.

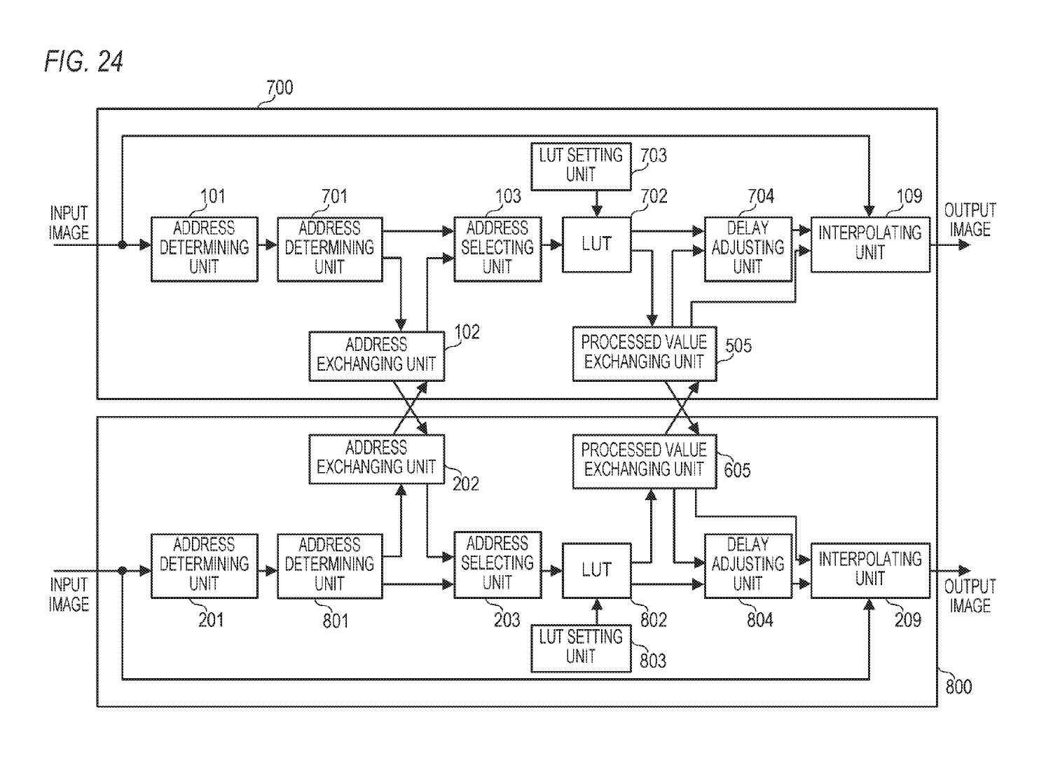

FIG. 24 is a block diagram showing an example of a configuration of an image processing system according to the present embodiment. As shown in FIG. 24, the image processing system according to the present embodiment includes the image processing apparatus 700 and an image processing apparatus 800. Alternatively, the image processing system may include three or more image processing apparatuses. The image processing apparatus 800 includes the address determining unit 201, an address determining unit 801, the address exchanging unit 202, the address selecting unit 203, an LUT 802, an LUT setting unit 803, a delay adjusting unit 804, the processed value exchanging unit 605, and the interpolating unit 209.

The address determining unit 801 has a similar function to the address determining unit 701. The LUT 802 has a similar function to the LUT 702. The LUT setting unit 803 has a similar function to the LUT setting unit 703. The delay adjusting unit 804 has a similar function to the delay adjusting unit 704.

Communication for transmitting and receiving addresses is performed between the address exchanging unit 102 and the address exchanging unit 202 and communication for transmitting and receiving processed values is performed between the processed value exchanging unit 505 and the processed value exchanging unit 605.

Moreover, in the image processing system according to the present embodiment, the address determining unit 701 divides an address space into two groups. In other words, the address determining unit 701 sets two partial ranges constituting a range of values which can be taken by an address. Alternatively, three or more partial ranges may be set as a plurality of partial ranges constituting a range of values which can be taken by an address. The plurality of partial ranges may be arbitrarily determined. In addition, the address determining unit 501 selects the address selecting unit 103 in a case where an address belongs to a group with smaller address values (a first group) and selects the address exchanging unit 102 in a case where an address belongs to a group with larger address values (a second group). The term of “address value” means “the magnitude of a numerical value which indicates the address”. Furthermore, the address determining unit 801 selects the address selecting unit 203 in a case where an address belongs to the second group and selects the address exchanging unit 202 in a case where an address belongs to the first group. Alternatively, the group with larger address values may be used as the first group and the group with smaller address values may be used as the second group.

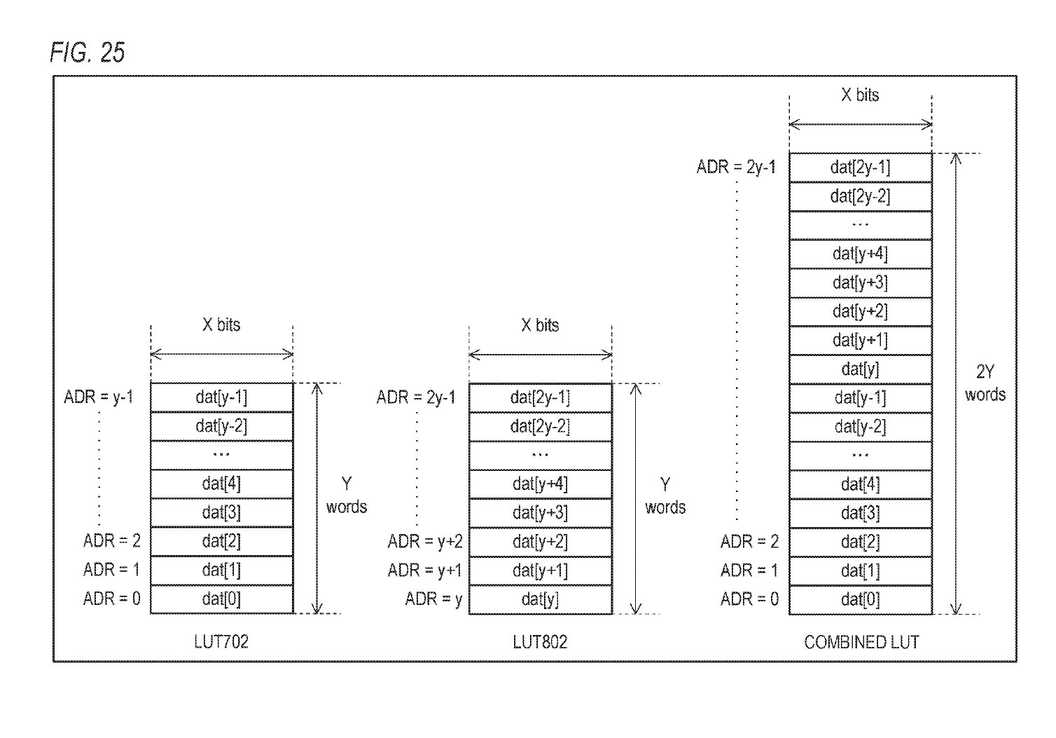

FIG. 25 shows an example of the LUT 702, the LUT 802, and a combined LUT obtained by combining the LUT 702 and the LUT 802 together. Processed values corresponding to addresses belonging to the first group are set in the LUT 702 and processed values corresponding to addresses belonging to the second group are set in the LUT 802. In addition, in the present embodiment, the address determining unit 701 and the address determining unit 801 select an output destination of an address so that the LUT 702 is referred to in a case where an address belonging to the first group is determined and the LUT 802 is referred to in a case where an address belonging to the second group is determined. Therefore, with the image processing system according to the present embodiment, image processing with higher accuracy can be performed as compared to a case where only one of the LUT 702 and the LUT 802 is used.

In the present embodiment, by a combining process, the interpolating unit 109 generates and outputs output image data in which each pixel value is either a pixel value based on a processed value of the LUT 702 or a pixel value based on a processed value of the LUT 802. Specifically, every time a processed value is input, the interpolating unit 109 outputs the input processed value (a pixel value based on the input processed value) as a pixel value of the output image data.

There are cases where a length of time required by the image processing apparatus 700 to acquire a processed value of the LUT 802 is significantly longer than a length of time required by the image processing apparatus 700 to acquire a processed value of the LUT 702. In addition, in a case where such a difference in processing times is not taken into consideration, the interpolating unit 109 may perform a process based on a processed value of the LUT 702 at a timing at which a process based on a processed value of the LUT 802 should have been performed and, consequently, an erroneous value may be obtained as a pixel value of the output image data.

In consideration thereof, in the present embodiment, a length of time required by a processed value to reach the interpolating unit 109 is adjusted using the delay adjusting unit 704. Specifically, transmission of a processed value of the LUT 702 to the interpolating unit 109 is intentionally delayed using the delay adjusting unit 704. Accordingly, the interpolating unit 109 can more reliably use a processed value to be used. As a result, a pixel value (a pixel value of input image data) corresponding to an input value belonging to the first group can be converted to a pixel value (a pixel value of the output image data) based on a processed value of the LUT 702. In addition, a pixel value (a pixel value of the input image data) corresponding to an input value belonging to the second group can be converted to a pixel value (a pixel value of the output image data) based on a processed value of the LUT 802.

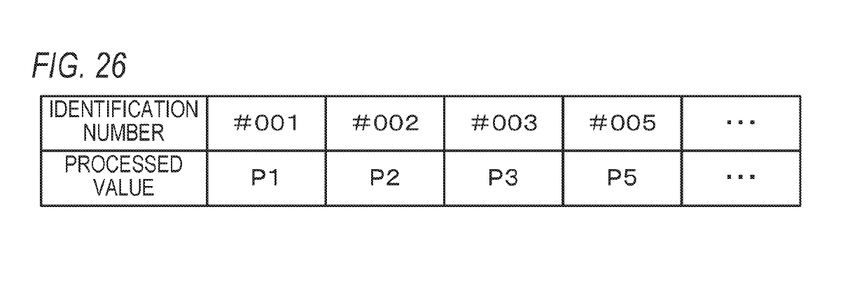

Processing by the delay adjusting unit 704 will be described with reference to FIG. 26. The address determining unit 701 determines an identification number corresponding to the address used for processing by the address determining unit 701. The identification number is incremented by one every time processing by the address determining unit 701 is performed. In addition, the identification number is initialized at a predetermined timing such as a timing of a horizontal synchronization signal. In a case where the address determining unit 701 outputs an address to the LUT 702 via the address selecting unit 103, the address determining unit 701 notifies the delay adjusting unit 704 of the identification number of the address. In a case where an address is input to the LUT 702, a processed value corresponding to the address is output from the LUT 702 to the delay adjusting unit 704. The delay adjusting unit 704 retains the input identification number and the processed value in association with each other.

The delay adjusting unit 704 reads (outputs) processed values in an order of identification numbers. In the example shown in FIG. 26, processed values with identification numbers #001, #002, and #003 are sequentially read. At this point, although the identification number following the identification number #003 is #004, the delay adjusting unit 704 does not retain a processed value corresponding to the identification number #004. A processed value not retained by the delay adjusting unit 704 is output from the LUT 802. Therefore, the delay adjusting unit 704 suspends reading of processed values until the processed value with the identification number #004 is acquired by the processed value exchanging unit 505 and output to the interpolating unit 109. The processed value exchanging unit 505 issues a notification to the delay adjusting unit 704 at a timing at which the processed value exchange is completed. The delay adjusting unit 704 restarts reading of processed values based on the notification. In the example shown in FIG. 26, after the processed value corresponding to the identification number #004 is output from the processed value exchanging unit 505 to the interpolating unit 109, the delay adjusting unit 704 reads a processed value corresponding to an identification number #005.

By performing such processing, the interpolating unit 109 can perform processing based on processed values in accordance with an order of identification numbers (an order of processing by the address determining unit 701). Moreover, there may be cases where a difference between a length of time required for acquiring a processed value of the LUT 702 and a length of time required for acquiring a processed value of the LUT 802 is determined in advance. In such a case, the delay adjusting unit 704 may determine a time at which reading of processed values (processed values of the LUT 702) is to be suspended based on the difference.

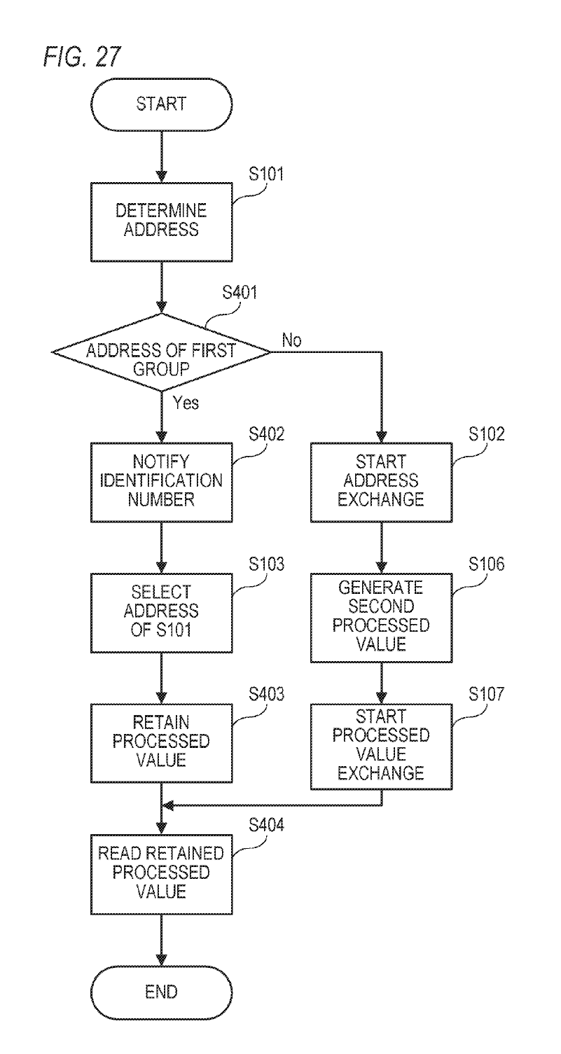

FIG. 27 is a flow chart showing an example of a processing flow of the present embodiment. Processes equivalent to the processes described in the embodiments presented above will be denoted by the same step numbers and detailed descriptions thereof will be omitted.

First, the process of S101 is performed. Next, in S401, the address determining unit 701 determines whether the address determined in S101 belongs to the first group or to the second group. In a case where the address determined in S101 belongs to the first group, the address determining unit 701 outputs the address determined in S101 to the address selecting unit 103 and processing is advanced to S402. In a case where the address determined in S101 belongs to the second group, the address determining unit 701 outputs the address determined in S101 to the address exchanging unit 102 and processing is advanced to S102.

In S402, the address determining unit 701 notifies the delay adjusting unit 704 of an identification number corresponding to the address determined in S101. Next, the process of S103 is performed. In S103, the address selecting unit 103 outputs the address determined in S101 to the LUT 702. Accordingly, a processed value corresponding to the address determined in S101 is output from the LUT 702 to the delay adjusting unit 704. In addition, in S403, the delay adjusting unit 704 retains the identification number input by the process of S402 and the processed value input by the process of S103 in association with each other. Subsequently, processing is advanced to S404.

In a case where processing is advanced to S102, the process of S102, the process of S106, and the process of S107 are performed. Accordingly, the processed value exchanging unit 505 acquires a processed value of the LUT 802 from the processed value exchanging unit 605 as a processed value corresponding to the address determined in S101. Subsequently, processing is advanced to S404.

In S404, the delay adjusting unit 704 outputs processed values of the LUT 702 to the interpolating unit 109 while adjusting output timings of the processed values of the LUT 702 using identification numbers or the like so that processed values are transmitted to the interpolating unit 109 in an order of processing by the address determining unit 701. In addition, the interpolating unit 109 performs processing based on processed values in accordance with an order of identification numbers (an order of processing by the address determining unit 701).

Moreover, during a period in which the image processing apparatus 700 performs processing with respect to the input image data to the image processing apparatus 700, the image processing apparatus 800 may perform processing with respect to the input image data to the image processing apparatus 800. In such a case, the LUT 802 performs reading two times (two types of reading) including reading of a processed value that corresponds to the address determined by the image processing apparatus 700 and reading of a processed value that corresponds to the address determined by the image processing apparatus 800. Therefore, in such a case, the LUT 802 must be operated at a rate that is twice a rate of the input image data or higher. For example, by raising an operating frequency (operating speed) of the LUT 802 to twice an operating frequency of other functional units or higher, the LUT 802 can be operated at a rate that is twice the rate of the input image data or higher.

In addition, during a period in which the image processing apparatus 700 performs processing with respect to the input image data to the image processing apparatus 700, the LUT 702 may be used (referred to) by the image processing apparatus 800. In such a case, the LUT 702 must be operated at a rate that is twice the rate of the input image data or higher due to reasons similar to that described above.

As described above, according to the present embodiment, a highly accurate image processing result can be obtained without increasing cost of an image processing apparatus by operating a plurality of image processing apparatuses in cooperation with each other. Specifically, an image processing result equivalent to that of a case where an LUT performing highly accurate image processing is used can be obtained without increasing cost of an image processing apparatus. The image processing system according to the present embodiment is capable of accommodating highly accurate image processing with respect to HDR image data. Moreover, while an example where image processing is performed using an LUT has been described in the present embodiment, this example is not restrictive. Methods of performing image processing are not particularly limited. For example, image processing which converts a pixel value by an operation using a function can be performed.

### Fifth Embodiment

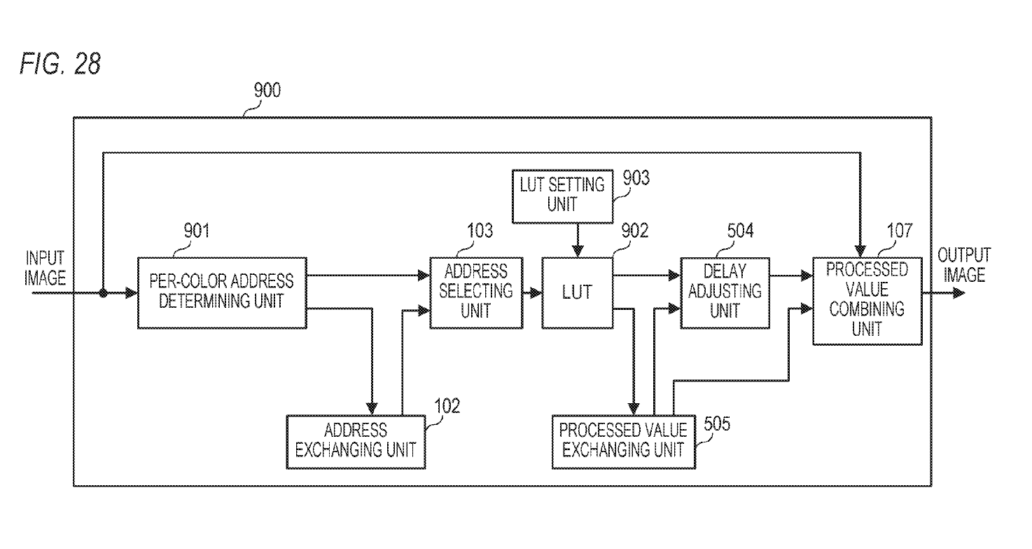

Hereinafter, an image processing apparatus and a control method thereof according to a fifth embodiment of the present invention will be described. FIG. 28 is a block diagram showing an example of a configuration of an image processing apparatus 900 according to the present embodiment. Functional units equivalent to the functional units described in the embodiments presented above will be denoted by the same reference characters and detailed descriptions thereof will be omitted.

A per-color address determining unit 901 determines a plurality of addresses respectively corresponding to a plurality of color components as addresses in accordance with pixel values of input image data. Specifically, for each of a plurality of color components, the per-color address determining unit 901 determines a value corresponding to the color component (a color component value) from a pixel value and determines an address in accordance with the determined color component value. In the present embodiment, an address corresponding to a first color component and an address corresponding to a second color component are determined. In addition, the per-color address determining unit 901 outputs the address corresponding to the first color component to the address selecting unit 103 and outputs the address corresponding to the second color component to the address exchanging unit 102. Moreover, all addresses may be output to one of the address exchanging unit 102 and the address selecting unit 103. Alternatively, three or more color components may be considered as the plurality of color components.

An LUT 902 is a lookup table for applying image processing to the input image data. In a case where an address (input value) is input, the LUT 902 outputs an output value (a processed value that is a pixel value after the image processing) corresponding to the input address. In a case where an address determined by the per-color address determining unit 901 is input to the LUT 902, image processing is to be applied to the input image data at the LUT 902. In the present embodiment, the per-color address determining unit 901 determines a plurality of addresses corresponding to a plurality of color components. Therefore, a plurality of LUTs corresponding to the plurality of color components can be set as the LUT 902. A detailed configuration of the LUT 902 will be described later. An LUT setting unit 903 performs settings of the LUT 902.

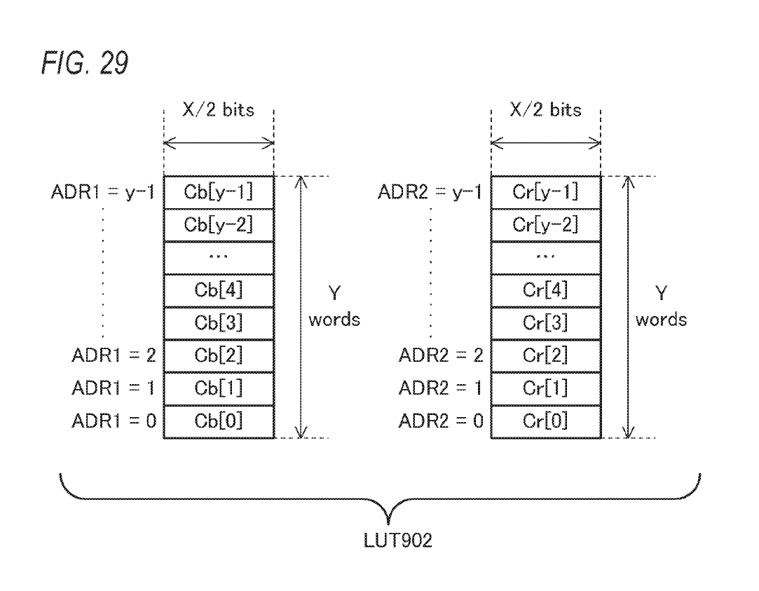

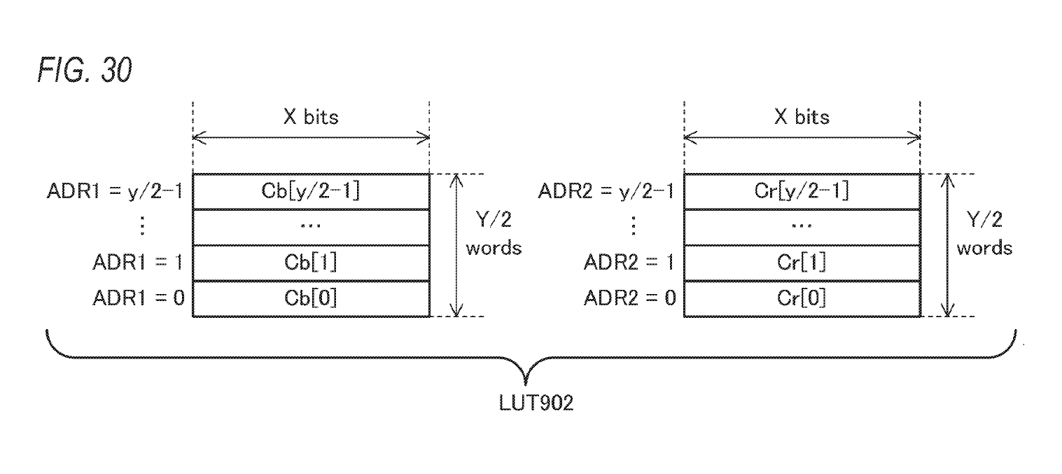

FIGS. 29 and 30 are diagrams showing an example of a configuration of the LUT 902. The LUT 902 in FIGS. 29 and 30 includes an LUT corresponding to the first color component (Cb) and an LUT corresponding to the second color component (Cr). In FIGS. 29 and 30, “ADR1” denotes an address corresponding to a value of the first color component and “ADR2” denotes an address corresponding to a value of the second color component. In this case, a capacity of the LUT 902 (a data capacity of an SRAM) is X×Y-number of bits. The LUT 902 in FIGS. 29 and 30 is used in a case of, for example, using the image processing apparatus 900 independently. Moreover, the first color component is not limited to “Cb” and the second color component is not limited to “Cr”.

In FIG. 29, respectively in the LUT corresponding to the first color component and the LUT corresponding to the second color component, a bit width of a processed value per word (per address) is X/2-number of bits and the number of words is Y-number of words. Therefore, a total capacity of the two LUTs is X×Y-number of bits and the LUT 902 shown in FIG. 29 can be set.

In FIG. 30, respectively in the LUT corresponding to the first color component and the LUT corresponding to the second color component, a bit width of a processed value per word (per address) is X-number of bits and the number of words is Y/2-number of words. Therefore, a total capacity of the two LUTs is X×Y-number of bits and the LUT 902 shown in FIG. 30 can also be set.

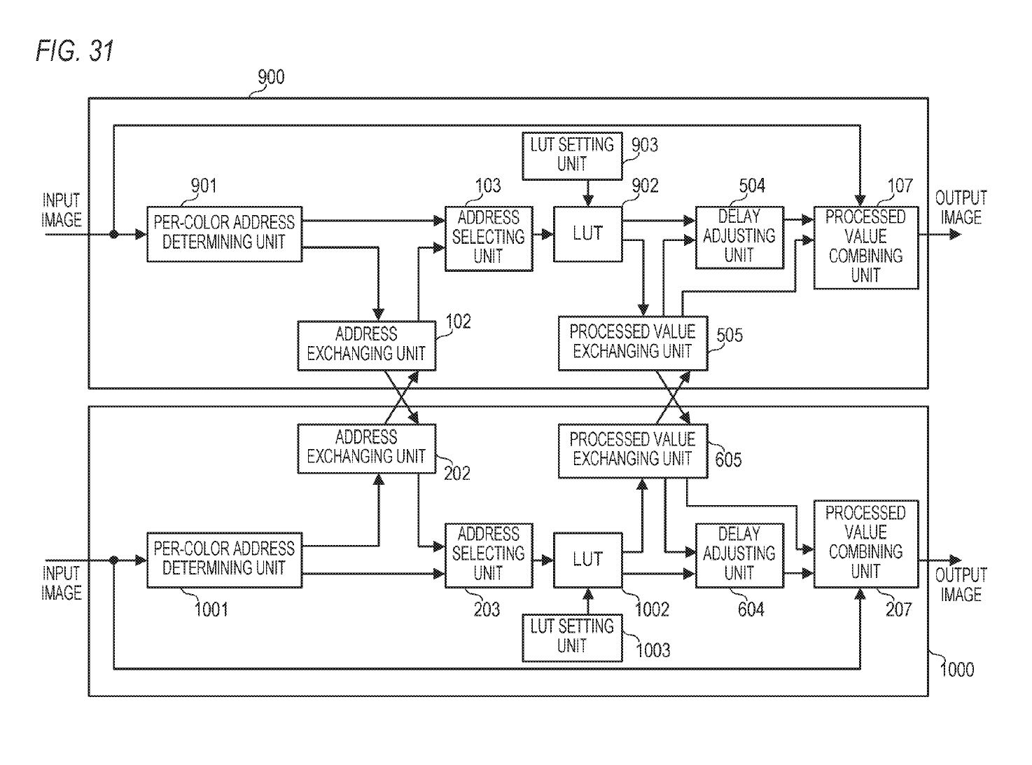

FIG. 31 is a block diagram showing an example of a configuration of an image processing system according to the present embodiment. As shown in FIG. 31, the image processing system according to the present embodiment includes the image processing apparatus 900 and an image processing apparatus 1000. Alternatively, the image processing system may include three or more image processing apparatuses. The image processing apparatus 1000 includes a per-color address determining unit 1001, the address exchanging unit 202, the address selecting unit 203, an LUT 1002, an LUT setting unit 1003, the delay adjusting unit 604, the processed value exchanging unit 605, and the processed value combining unit 207.

The per-color address determining unit 1001 has a similar function to the per-color address determining unit 901. The LUT 1002 has a similar function to the LUT 902. The LUT setting unit 1003 has a similar function to the LUT setting unit 903.

Communication for transmitting and receiving addresses is performed between the address exchanging unit 102 and the address exchanging unit 202 and communication for transmitting and receiving processed values is performed between the processed value exchanging unit 505 and the processed value exchanging unit 605.

In addition, in the image processing system according to the present embodiment, the per-color address determining unit 901 outputs an address corresponding to the first color component to the address selecting unit 103 and outputs an address corresponding to the second color component to the address exchanging unit 102. In addition, the per-color address determining unit 1001 outputs an address corresponding to the second color component to the address selecting unit 203 and outputs an address corresponding to the first color component to the address exchanging unit 202.

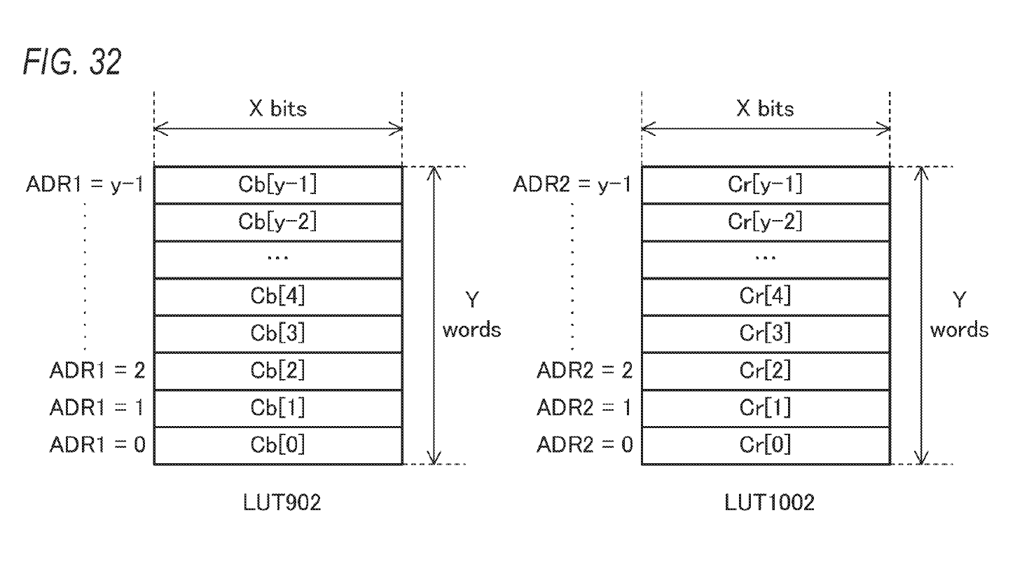

FIG. 32 shows examples of the LUT 902 and the LUT 1002. In FIG. 32, the LUT 902 is an LUT corresponding to the first color component and the LUT 1002 is an LUT corresponding to the second color component. In a case where the LUT 902 does not include an LUT corresponding to other color component (the second color component), a highly accurate LUT corresponding to the first color component can be set as the LUT 902. In a similar manner, in a case where the LUT 1002 does not include an LUT corresponding to other color component (the first color component), a highly accurate LUT corresponding to the second color component can be set as the LUT 1002. In FIG. 32, respectively in the LUT 902 and the LUT 1002, a bit width of a processed value per word (per address) is X-number of bits and the number of words is Y-number of words. Therefore, accuracy of the LUT 902 in FIG. 32 is higher than the LUT shown in FIGS. 29 and 30 (an LUT corresponding to the first color component) and accuracy of the LUT 1002 in FIG. 32 is higher than the LUT shown in FIGS. 29 and 30 (an LUT corresponding to the second color component).

In addition, in the present embodiment, the per-color address determining unit 901 and the per-color address determining unit 1001 select an output destination of an address so that the LUT 902 is referred to with respect to an address corresponding to the first color component and the LUT 1002 is referred to with respect to an address corresponding to the second color component. Therefore, with the image processing system according to the present embodiment, image processing with higher accuracy can be performed as compared to a case where only one of the LUT 902 and the LUT 1002 is used.

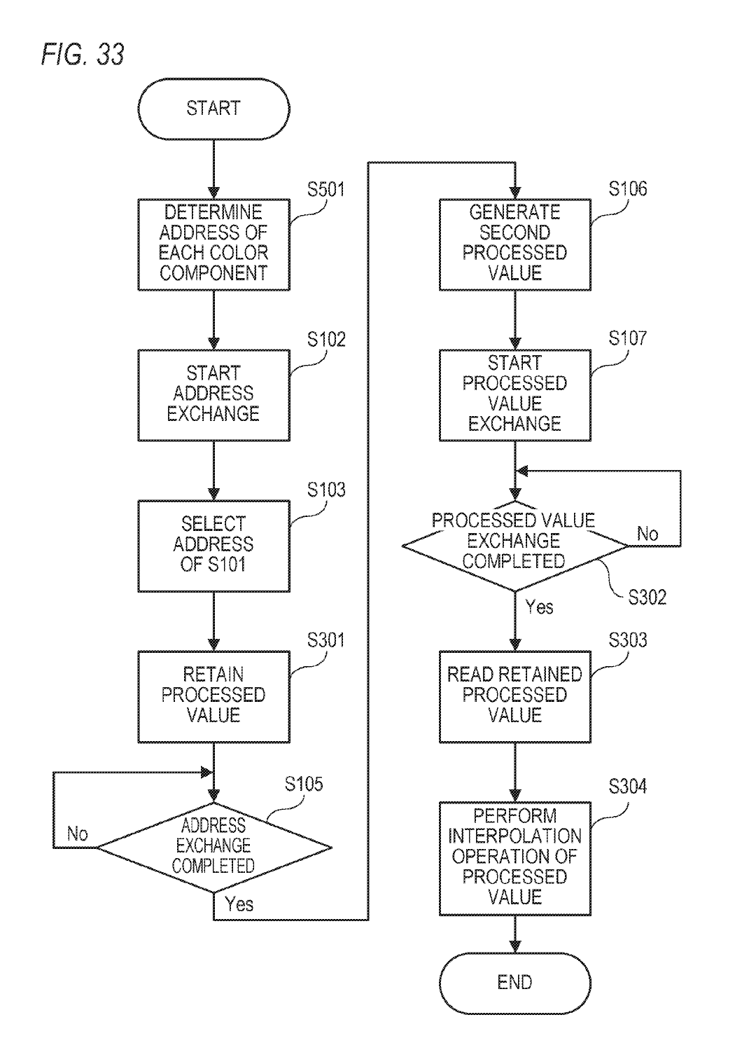

FIG. 33 is a flow chart showing an example of a processing flow of the present embodiment. Processes equivalent to the processes described in the embodiments presented above will be denoted by the same step numbers and detailed descriptions thereof will be omitted. First, in S501, the per-color address determining unit 901 determines an address corresponding to the first color component and an address corresponding to the second color component based on pixel values of the input image data. The per-color address determining unit 901 outputs the address corresponding to the first color component (the address determined in S501) to the address selecting unit 103 and outputs the address corresponding to the second color component (the address determined in S501) to the address exchanging unit 102. Subsequently, processes of S102 to S304 are performed.

The present embodiment is effective in a case of individually performing image processing with respect to each color component and can also be applied to a debayering (de-mosaicing) process of a RAW image. For example, in a case where there are color components such as R, G1, G2, and B, image processing on the respective color components can be executed by sharing among plurality of image processing apparatuses.

Moreover, during a period in which the image processing apparatus 900 performs processing with respect to the input image data to the image processing apparatus 900, the image processing apparatus 1000 may perform processing with respect to the input image data to the image processing apparatus 1000. In such a case, the LUT 1002 performs reading two times (two types of reading) including reading of a processed value that corresponds to the address determined by the image processing apparatus 900 and reading of a processed value that corresponds to the address determined by the image processing apparatus 1000. Therefore, in such a case, the LUT 1002 must be operated at a rate that is twice a rate of the input image data or higher. For example, by raising an operating frequency (operating speed) of the LUT 1002 to twice an operating frequency of other functional units or higher, the LUT 1002 can be operated at a rate that is twice the rate of the input image data or higher.

In addition, during a period in which the image processing apparatus 900 performs processing with respect to the input image data to the image processing apparatus 900, the LUT 902 may be used (referred to) by the image processing apparatus 1000. In such a case, the LUT 902 must be operated at a rate that is twice the rate of the input image data or higher due to reasons similar to that described above.

Moreover, among color components of an image, there are color components for which one pixel value is set for every two pixels such as Cb and Cr in a Y:Cb:Cr=4:2:2 format. In a case of using such Cb and Cr, an LUT can be operated at a same rate as a rate of the input image data.

Furthermore, there are cases where information of Cb and Cr is alternately input for each line as in the case of Cb and Cr in a Y:Cb:Cr=4:2:0 format. In this case, one of processing with respect to the input image data of the image processing apparatus 900 and processing with respect to the input image data of the image processing apparatus 1000 may be delayed by one line using a line memory or the like. Accordingly, the image processing apparatus 900 and the image processing apparatus 1000 can be prevented from using a same LUT (at least one of the LUT 902 and the LUT 1002) at the same time. Even in such cases, a lookup table can be operated at a same rate as a rate of the input image data.

In addition, there are cases where only one color component value exists for each coordinate constituting an image such as in a Bayer array of a RAW image. In this case, only an LUT of one color component is to be referred to in a case of performing image processing of a given coordinate. In consideration thereof, two LUTs with color components that differ from each other may be set as the LUT 902 and the LUT 1002 so that the respective image processing apparatuses do not refer to the same LUT at the same time. Accordingly, a lookup table can be operated at a same rate as a rate of the input image data.

Moreover, in the case of the Y:Cb:Cr=4:2:0 format, image processing of Cb and image processing of Cr can be prevented from taking place at the same time. In such a case, operation of an LUT not being used for image processing among the LUT 902 and the LUT 1002 can be suspended. Accordingly, effects such as reducing power consumption by the image processing system or reducing heat generation by suppressing local concentration of power can be achieved.

As described above, according to the present embodiment, a highly accurate image processing result can be obtained without increasing cost of an image processing apparatus by operating a plurality of image processing apparatuses in cooperation with each other. Specifically, an image processing result equivalent to that of a case where an LUT performing highly accurate image processing is used can be obtained without increasing cost of an image processing apparatus. The image processing system according to the present embodiment is also capable of accommodating highly accurate image processing with respect to HDR image data. Moreover, while an example where image processing is performed using an LUT has been described in the present embodiment, this example is not restrictive. Methods of performing image processing are not particularly limited. For example, image processing which converts a pixel value by an operation using a function can be performed.

Moreover, the first to fifth embodiments merely represent examples and configurations obtained by appropriately modifying and altering the configurations of the first to fifth embodiments without departing from the spirit and scope of the present invention are also included in the present invention. Configurations obtained by appropriately combining the configurations of the first to fifth embodiments are also included in the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-148892, filed on Jul. 28, 2015, and Japanese Patent Application No. 2016-128527, filed on Jun. 29, 2016, which are hereby incorporated by reference herein in their entirety.

What is claimed is:

1. An image processing apparatus comprising:
a first processing unit configured to apply first image processing to input image data;
a communicating unit configured, by communicating with other image processing apparatus having a second processing unit performing second image processing that differs from the first image processing, to cause the second processing unit to perform the second image processing on the input image data, and to acquire a result of the second image processing applied to the input image data from the other image processing apparatus; and
a combining unit configured to perform a combining process of combining together a result of the first image processing by the first processing unit and the result of the second image processing acquired by the communicating unit.

2. The image processing apparatus according to claim 1, wherein
in a case where an input value in accordance with a pixel value is input, the first processing unit and the second processing unit each output an output value corresponding to the input value,
an input value in accordance with a pixel value of the input image data is input to the first processing unit,
the communicating unit:
outputs the input value in accordance with the pixel value of the input image data to the other image processing apparatus to cause the second processing unit to output an output value corresponding to the input value; and
acquires the output value output from the second processing unit from the other image processing apparatus, and
the combining process is a process of combining together an output value of the first processing unit corresponding to the input value in accordance with the pixel value of the input image data and an output value of the second processing unit corresponding to the input value.

3. The image processing apparatus according to claim 2, wherein
the first processing unit outputs a first partial value which is any of a plurality of partial values constituting a pixel value obtained by applying predetermined image processing to a pixel value, and
the second processing unit outputs a second partial value which is any of the plurality of partial values and which differs from the first partial value.

4. The image processing apparatus according to claim 3, wherein
the input value in accordance with the pixel value of the input image data includes a first input value corresponding to a first color component value of the pixel value and a second input value corresponding to a second color component value of the pixel value,
the first input value is input to the first processing unit, and
the communicating unit outputs the second input value to the other image processing apparatus to cause the second processing unit to output an output value corresponding to the second input value.

5. The image processing apparatus according to claim 1, further comprising
a detecting unit configured to detect a first region and a second region among regions of an image represented by the input image data, wherein
the first image processing corresponds to one region of the first region and the second region,
the second image processing corresponds to the other region of the first region and the second region,
the communicating unit:
outputs output image data that is the input image data in a region at least including the other region to the other image processing apparatus based on a result of detection by the detecting unit to cause the second processing unit to perform the second image processing on the output image data; and
acquires a result of applying the second image processing to the output image data from the other image processing apparatus, and
the combining unit generates, by the combining process, combined image data representing a combined image which is an image obtained by applying the first image processing to the one region and which is an image obtained by applying the second image processing to the other region.

6. The image processing apparatus according to claim 5, wherein
the output image data is the input image data in the other region.

7. The image processing apparatus according to claim 5, wherein
the first region corresponds to display with a wider dynamic range than display corresponding to the second region.

8. The image processing apparatus according to claim 1, wherein
in a case where an input value in accordance with a pixel value is input, the first processing unit and the second processing unit each output an output value corresponding to the input value,
in a case where a first input value is included in one or more input values in accordance with a pixel value of the input image data, the first input value is input to the first processing unit,
in a case where a second input value is included in one or more input values in accordance with the pixel value of the input image data, the communicating unit:
outputs the second input value to the other image processing apparatus to cause the second processing unit to output an output value corresponding to the second input value; and
acquires the output value output from the second processing unit from the other image processing apparatus, and
in a case where the first input value and the second input value are included in the one or more input values in accordance with the pixel value of the input image data, the combining process is a process of combining together an output value of the first processing unit corresponding to the first input value and an output value of the second processing unit corresponding to the second input value.

9. The image processing apparatus according to claim 1, wherein
in a case where an input value in accordance with a pixel value is input, the first processing unit and the second processing unit each output an output value corresponding to the input value,
a range of values which can be taken by the input value is constituted by a plurality of partial ranges including a first range and a second range,
in a case where an input value in accordance with a pixel value of the input image data belongs to the first range, the input value in accordance with the pixel value of the input image data is input to the first processing unit,
in a case where the input value in accordance with the pixel value of the input image data belongs to the second range, the communicating unit:
outputs the input value in accordance with the pixel value of the input image data to the other image processing apparatus to cause the second processing unit to output an output value corresponding to the input value in accordance with the pixel value of the input image data; and
acquires the output value output from the second processing unit from the other image processing apparatus, and
the combining unit generates, by the combining process, image data in which each pixel value is a pixel value based on an output value of the first processing unit or a pixel value based on an output value of the second processing unit.

10. The image processing apparatus according to claim 9, further comprising
a delaying unit configured to delay transmission of the output value of the first processing unit to the combining unit so that a pixel value of the input image data corresponding to an input value belonging to the first range is converted to a pixel value based on the output value of the first processing unit and a pixel value of the input image data corresponding to an input value belonging to the second range is converted to a pixel value based on the output value of the second processing unit.

11. An image processing system comprising a first image processing apparatus and a second image processing apparatus,
the first image processing apparatus including:
a first processing unit configured to apply first image processing to first input image data that is image data input to the first image processing apparatus;
a first communicating unit configured to communicate with the second image processing apparatus; and
a first combining unit configured to perform a first combining process of combining together a result of the first image processing by the first processing unit and a result of communication by the first communicating unit,
the second image processing apparatus including a second processing unit configured to perform second image processing that differs from the first image processing, wherein
the first communicating unit, by communicating with the second image processing apparatus, causes the second processing unit to perform the second image processing on the first input image data, and acquires a result of the second image processing applied to the first input image data from the second image processing apparatus, and
the first combining process is a process of combining together a result of the first image processing on the first input image data and the result of the second image processing acquired by the first communicating unit.

12. The image processing system according to claim 11, wherein
the second image processing apparatus further includes:
a second communicating unit configured to communicate with the first image processing apparatus; and
a second combining unit configured to perform a second combining process of combining together a result of the second image processing by the second processing unit and a result of communication by the second communicating unit,
the second processing unit applies the second image processing to second input image data that is image data input to the second image processing apparatus,
the second communicating unit, by communicating with the first image processing apparatus, causes the first processing unit to perform the first image processing on the second input image data, and acquires a result of the first image processing applied to the second input image data from the first image processing apparatus, and
the second combining process is a process of combining together a result of the second image processing on the second input image data and the result of the first image processing acquired by the second communicating unit.

13. The image processing system according to claim 11, wherein
in a case where an input value in accordance with a pixel value is input, the first processing unit and the second processing unit each output an output value corresponding to the input value,
an input value in accordance with a pixel value of the first input image data is input to the first processing unit,
the first communicating unit:
outputs the input value in accordance with the pixel value of the first input image data to the second image processing apparatus to cause the second processing unit to output an output value corresponding to the input value; and
acquires the output value output from the second processing unit from the second image processing apparatus, and
the first combining process is a process of combining together an output value of the first processing unit corresponding to the input value in accordance with the pixel value of the first input image data and an output value of the second processing unit corresponding to the input value.

14. The image processing system according to claim 13, wherein
the second image processing apparatus further includes:
a second communicating unit configured to communicate with the first image processing apparatus; and
a second combining unit configured to perform a second combining process of combining together a result of the second image processing by the second processing unit and a result of communication by the second communicating unit,
an input value in accordance with a pixel value of second input image data which is input to the second image processing apparatus is input to the second processing unit,
the second communicating unit:
outputs the input value in accordance with the pixel value of the second input image data to the first image processing apparatus to cause the first processing unit to output an output value corresponding to the input value; and
acquires the output value output from the first processing unit from the first image processing apparatus, and
the second combining process is a process of combining together an output value of the second processing unit corresponding to the input value in accordance with the pixel value of the second input image data and an output value of the first processing unit corresponding to the input value.

15. The image processing system according to claim 13, wherein
the first processing unit outputs a first partial value which is any of a plurality of partial values constituting a pixel value obtained by applying predetermined image processing to a pixel value, and
the second processing unit outputs a second partial value which is any of the plurality of partial values and which differs from the first partial value.

16. The image processing system according to claim 11, wherein
the first image processing apparatus further includes a first detecting unit configured to detect a first region and a second region among regions of an image represented by the first input image data,
the first image processing corresponds to one region of the first region and the second region,
the second image processing corresponds to the other region of the first region and the second region,
the first communicating unit:
outputs first output image data that is the first input image data in a region at least including the other region to the second image processing apparatus based on a result of detection by the first detecting unit to cause the second processing unit to perform the second image processing on the first output image data; and
acquires a result of applying the second image processing to the first output image data from the second image processing apparatus, and
the first combining unit generates, by the first combining process, first combined image data representing a first combined image which is an image obtained by applying the first image processing to the one region and which is an image obtained by applying the second image processing to the other region.

17. The image processing system according to claim 16, wherein
the second image processing apparatus further includes:
a second communicating unit configured to communicate with the first image processing apparatus;
a second detecting unit configured to detect the first region and the second region among regions of an image represented by second input image data that is image data input to the second image processing apparatus; and
a second combining unit configured to perform a second combining process of combining together a result of the second image processing by the second processing unit and a result of communication by the second communicating unit,
the second processing unit applies the second image processing to the second input image data,
the first image processing corresponds to one region of the first region and the second region,
the second image processing corresponds to the other region of the first region and the second region,
the second communicating unit:
outputs second output image data that is the second input image data in a region at least including the one region to the first image processing apparatus based on a result of detection by the second detecting unit to cause the first processing unit to perform the first image processing on the second output image data; and
acquires a result of applying the first image processing to the second output image data from the first image processing apparatus, and
the second combining unit generates, by the second combining process, second combined image data representing a second combined image which is an image obtained by applying the first image processing to the one region and which is an image obtained by applying the second image processing to the other region.

18. The image processing system according to claim 17, wherein
the first image processing apparatus further includes a first setting unit configured to set, as the first image processing, image processing corresponding to the first region or image processing corresponding to the second region,
the second processing apparatus further includes a second setting unit configured to set, as the second image processing, image processing corresponding to the first region or image processing corresponding to the second region,
in a case where the first region detected by the first detecting unit is larger than the first region detected by the second detecting unit:
the first setting unit sets the image processing corresponding to the first region as the first image processing; and
the second setting unit sets the image processing corresponding to the second region as the second image processing, and
in a case where the first region detected by the first detecting unit is smaller than the first region detected by the second detecting unit:
the first setting unit sets the image processing corresponding to the second region as the first image processing; and
the second setting unit sets the image processing corresponding to the first region as the second image processing.

19. The image processing system according to claim 16, wherein
the first output image data is the first input image data in the other region.

20. The image processing system according to claim 17, wherein
the first output image data is the first input image data in the other region, and
the second output image data is the second input image data in the one region.

21. The image processing system according to claim 16, wherein
the first region corresponds to display with a wider dynamic range than display corresponding to the second region.

22. A control method of an image processing apparatus including a first processing unit configured to perform first image processing,
the control method comprising:
a processing step of causing the first processing unit to perform the first image processing on input image data that is image data input to the image processing apparatus;
a communicating step of, by communicating with other image processing apparatus having a second processing unit performing second image processing that differs from the first image processing, causing the second processing unit to perform the second image processing on the input image data, and acquiring a result of the second image processing applied to the input image data from the other image processing apparatus; and
a combining step of performing a combining process of combining together a result of the first image processing acquired in the processing step and the result of the second image processing acquired in the communication step.

23. A non-transitory computer readable medium that stores a program, wherein
the program causes a computer to execute a control method of an image processing apparatus including a first processing unit configured to perform first image processing, and
the control method includes:
a processing step of causing the first processing unit to perform the first image processing on input image data that is image data input to the image processing apparatus;
a communicating step of, by communicating with other image processing apparatus having a second processing unit performing second image processing that differs from the first image processing, causing the second processing unit to perform the second image processing on the input image data, and acquiring a result of the second image processing applied to the input image data from the other image processing apparatus; and
a combining step of performing a combining process of combining together a result of the first image processing acquired in the processing step and the result of the second image processing acquired in the communication step.
